(19) United States
(12) Patent Application Publication
(10) Pub. No.: US 2016/0161874 A1
(43) Pub. Date: Jun. 9, 2016

(54) MAGNETIC TONER

(71) Applicant: CANON KABUSHIKI KAISHA, Ohta-ku, Tokyo (JP)

(72) Inventors: Katsuhisa Yamazaki, Numazu-shi (JP); Koji Nishikawa, Susono-shi (JP); Daisuke Yoshiba, Suntou-gun (JP); Shotaro Nomura, Suntou-gun (JP); Hiroki Akiyama, Toride-shi (JP); Masami Fujimoto, Suntou-gun (JP)

(21) Appl. No.: 14/900,590

(22) PCT Filed: Jul. 30, 2014
(86) PCT No.: PCT/JP2014/070658

§ 371 Date: Dec. 21, 2015

(30) Foreign Application Priority Data
Jul. 31, 2013 (JP) 2013-158910

(51) Int. Cl. G03G 9/097

(52) U.S. Cl. CPC G03G 9/09725

(57) ABSTRACT

A magnetic toner comprising a toner particle containing a styrene resin as a binder resin and a magnetic substance, and a first inorganic fine particle on surface of the toner particle and an organic-inorganic composite fine particle on the surface of the toner particle, wherein the first inorganic fine particle i) contains at least one inorganic oxide fine particle selected from the group consisting of silica fine particle, titanium oxide fine particle and alumina fine particle, with the proviso that the inorganic oxide fine particle contains silica fine particle in an amount of 85 mass % or more based on the total mass of the inorganic oxide fine particle, and ii) has a number-average particle diameter (D1) of 5 nm or more and 25 nm or less, the coverage ratio A of the toner-particle surface with the first inorganic fine particle is 45.0% or more and 70.0% or less.

### TECHNICAL FIELD

The present invention relates to electrophotography, an image forming method for visualizing an electrostatic image and a magnetic toner for use in a toner jet.

### BACKGROUND ART

It has been strongly desired that image forming apparatuses employing electrophotography method are operated at a higher speed with higher reliability. In addition, the apparatuses are highly required to consume less energy. To satisfy these requirements, a toner is highly demanded to have excellent low-temperature fixability. The low-temperature fixability of a toner is generally related to the viscosity thereof, and the property of being melted quickly by heat during fixation (so-called the sharp-melting properties) is required. However, a toner having satisfactory low-temperature fixability is vulnerable to external stress applied when the toner is stirred in a developer and when the temperature of a developer main-body increases. As a result, embedment of an external additive(s) occurs to reduce durability and a toner adheres to members. Such problems are likely to occur.

In addition, if low-temperature fixability alone is demanded, it is effective to reduce the viscosity of a toner; however, end-portion offset often occurs.

Generally, a printer is often used by feeding a wide variety of sizes of paper sheets from small-size sheets such as post cards and envelops to large size sheets such as A3 sheets one after another. Particularly when a large-size (A4 or A3) paper sheet is fed immediately after continuous printing of small-size paper sheets, hot offset occurs at the both end portions of the paper sheet at which fixation is made by both ends of an overheated pressure roller. This phenomenon called hot offset is hereinafter referred to as “end-portion offset caused by temperature increase of a fixing unit non-paper feeding region”.

PTL 1 proposes use of a polyester resin, which is at least partially modified with a compound having a long-chain alkyl group having a predetermined number of carbon atoms and a hydroxy group or a carboxyl group at an end, and proposes that a toner excellent in e.g., charge stability, fixability, storage stability and development characteristics can be obtained by use of such a polyester resin. In this case, some effect is produced on low-temperature fixability; however, sharp melting properties are demanded so much that end-portion offset resistance and long-term development stability in continuous high-speed printing have room for improvement.

In PTL 2, a development/transfer step is stabilized by controlling the total coverage ratio of toner base particles with an external additive. Indeed, a certain effect is produced on predetermined toner base particles by controlling a calculated theoretical coverage. However, if the use as mentioned above is presumed, it is difficult to have satisfactory fixability and developability at the same time. Because of this, there is room for improvement.

Furthermore, PTL 3 and PTL 4 propose that long-term stability is improved by adding a spacer, thereby suppressing embedding of an external additive. In this case, however, it is difficult to have satisfactory fixability and developability at the same time. Because of this, there is room for improvement.

As described above, a toner having high developability and excellent low-temperature fixability and excellent end-portion offset resistance is necessary for use in high-speed energy-saving printers; however, there are many technical problems to attain this at present. There is room for improvement.

### CITATION LIST

### Patent Literature

PTL 1: Japanese Patent No. 3015244

PTL 2: Japanese Patent Application Laid-Open No. 2007-293043

PTL 3: Japanese Patent Application Laid-Open No. 2005-202131

PTL 4: Japanese Patent Application Laid-Open No. 2013-92748

### SUMMARY OF INVENTION

### Technical Problem

The present invention is directed to providing a toner obtained by overcoming the aforementioned problems.

The present invention is directed to providing a toner having satisfactory long-term stability, low-temperature fixability and end-portion offset resistance in high-speed printing.

### Solution to Problem

According to one aspect of the present invention, there is provided a magnetic toner having a toner particle containing a styrene resin as a binder resin and a magnetic substance, and a first inorganic fine particle on surface of the toner particle and an organic-inorganic composite fine particle on the surface of the toner particle, wherein: the first inorganic fine particle i) contains at least one inorganic oxide fine particle selected from the group consisting of silica fine particle, titanium oxide fine particle and alumina fine particle, with the proviso that the inorganic oxide fine particle contains silica fine particle in an amount of 85 mass % or more based on the total mass of the inorganic oxide fine particle, and ii) has a number-average particle diameter (D1) of 5 nm or more and 25 nm or less, the coverage ratio A of the toner-particle surface with the first inorganic fine particle is 45.0% or more and 70.0% or less, wherein: the organic-inorganic composite fine particle comprises a vinyl resin particle, and a second inorganic fine particle embedded in the vinyl resin particle, the vinyl resin particle comprises a vinyl resin component containing THF-insoluble matter in an amount of 95 mass % or more based on the mass of the vinyl resin component, the content of the organic-inorganic composite fine particle is 0.5 mass % or more and 3.0 mass % or less based on the mass of the toner particle, wherein: when the weight average molecular weight of THF-soluble matter of the toner measured by size exclusion chromatography multi-angle scattering (SEC-MALLS) is defined as Mw, and an average rotation radius of THF-soluble matter of the toner measured by size exclusion chromatography multi-angle scattering (SEC-MALLS) is defined as Rw, the Mw is 5000 or more and 20000 or less, and the ratio of the Rw to Mw, (Rw/Mw) is 3.0×10⁻³ or more and 6.5×10⁻³ or less, and wherein: the viscosity of the toner at 110° C. measured by a flow tester is 5000 Pa·s or more and 25000 Pa·s or less.

### Advantageous Effects of Invention

According to the present invention, long-term stability, low-temperature fixability and end-portion offset resistance in high-speed printing can be obtained at the same time.

Further features of the present invention will become apparent from the following description of exemplary embodiments with reference to the attached drawings.

### BRIEF DESCRIPTION OF THE DRAWINGS

FIG. 1 is a schematic view of a mixing apparatus that can be used for mixing external additive(s).

FIG. 2 is a schematic view of the structure of a stirring member used in a mixing apparatus.

### DESCRIPTION OF EMBODIMENTS

Preferred embodiments of the present invention will now be described in detail in accordance with the accompanying drawings.

In order to obtain a toner having satisfactory low-temperature fixability, it is necessary to quickly melt a toner in a short time when the toner passes through a nip of a fixing unit. In order to obtain a toner having satisfactory offset resistance, it is necessary to improve the release properties of a toner from a fixing roller. Generally, for quickly melting a toner, a method for controlling the melting characteristics of a resin component serving as a main component of the toner is known. As an approach for improving the release properties of a toner, adding a release agent and controlling the viscoelasticity of the resin component are known. However, if the melting characteristics and viscoelasticity of the resin component itself are controlled, low-temperature fixability often trades off offset resistance. As a result of the studies conducted by the present inventions, it was found that particularly in a high-speed printing system, it is necessary to improve the level of low-temperature fixability while maintaining the offset level by a temperature increase of a fixing unit non-paper feeding region. More specifically, particularly in a high-speed printing system, it is necessary to enlarge a fixable region.

In the meantime, to attain a high-speed printing system, developability (long-term developability) needs to be stabilized for a long time during operation. In the circumstances, a toner satisfying the low-temperature fixability as mentioned above is vulnerable to external stress applied when the toner is stirred in a developer and when the temperature of a developer main-body increases. As a result, durability of a toner decreases due to embedding of an external additive and a toner adheres to members. Such phenomena are likely to occur.

The present inventors have conducted intensive studies with the view to attaining low-temperature fixability, end-portion offset resistance and long-term developability at the same time. As a result, we found that these can be attained by the following constitutions. First, the relationship between the coverage ratio of the surface of a magnetic toner particle with first inorganic fine particle and the coverage ratio with first inorganic fine particle adhered to the surface of a magnetic toner particle is allowed to fall within a predetermined range by using a predetermined organic-inorganic composite fine particle. In addition, the molecular weight and branching degree of the magnetic toner and viscosity of magnetic toner at 110° C. are allowed to fall within predetermined ranges.

First, the magnetic toner of the present invention will be schematically described. In the magnetic toner of the present invention, sharp melting properties are improved by achieving lower-viscosity in melting. Low viscosity herein is achieved not by a conventional manner, i.e., reducing the molecular weight and glass transition temperature of a binder resin of a magnetic toner, but by controlling the degree of branching of a magnetic toner to a linear type. In this manner, low viscosity is attained in melting while maintaining durability.

In the magnetic toner of the present invention, for maintaining durability and improving end-portion offset in high-speed printing, an organic-inorganic composite fine particle, which has a predetermined shape and predetermined THF (tetrahydrofuran) insoluble matter, is added in a proper amount.

In the magnetic toner of the present invention, coverage ratio with first inorganic fine particle adhered to the surface of a magnetic toner particle, is made appropriate. If a magnetic toner is constituted as mentioned above, heat is easily transmitted to the magnetic toner, with the result that the magnetic toner easily melts and deforms, and a release agent easily bleeds out. The release properties of a toner from a fixing film have improved more than ever before.

More specifically, the toner of the present invention is characterized in that the binder resin is a styrene resin. Provided that the weight average molecular weight of THF-soluble matter of the toner is measured by size exclusion chromatography multi-angle scattering (SEC-MALLS) is represented by Mw and an average rotation radius of the THF-soluble matter is represented by Rw, it is characterized in that the Mw is 5000 or more and 20000 or less, and the ratio of the Rw to Mw, (Rw/Mw) is 3.0×10⁻³ or more and 6.5×10⁻³ or less.

Furthermore, the weight average molecular weight (Mw) is preferably 5000 or more and 15000 or less and the ratio of the average rotation radius (Rw) to the weight average molecular weight (Mw) [Rw/Mw] is preferably 5.0×10⁻³ or more and 6.5×10⁻³ or less. Note that the unit of the average rotation radius (Rw) is “nm”.

Herein, an inertial square radius (Rg²) is a value generally showing spread per molecule. The value [Rw/Mw], which is obtained by dividing the square root thereof, i.e., an average rotation radius, Rw (Rw=(Rg²)^{1/2}) by the weight average molecular weight (Mw), is considered to show the degree of branching per molecule. Accordingly, the smaller the value [Rw/Mw], the smaller the spread for the molecular weight. Accordingly, the degree of branching of the molecule is considered to be large. Conversely, the larger the value [Rw/Mw], the larger the spread for the molecular weight. Accordingly, the molecule is considered to be linear.

The weight average molecular weight obtained by SEC-MALLS mentioned above and the inertial square radius will be described. The molecular weight distribution determined by SEC is based on molecular size and intensity represents the presence amount. In contrast, if the light scattering intensity obtained by SEC-MALLS (SEC serving as a separation tool is connected to a multi-angle light scattering detector such that the weight average molecular weight (Mw) and spread of a molecule (inertial square radius) can be measured) is used, the molecular weight distribution not based on the molecular size can be obtained.

In conventional SEC, the measurement molecules are classified by size when the molecules pass through a column since the column exerts a sieve effect, and eluted sequentially from large molecules to small molecules. In this way, the molecular weights of them are measured. In this case, if a linear polymer and a branched polymer having equivalent molecular weight are present, the former one elutes earlier since the molecular size thereof is larger in a solution. Accordingly, the molecular weight of a branched polymer usually measured smaller than a true molecular weight by SEC. In contrast, the light scattering method that is used in the present invention uses Rayleigh scattering of a measurement molecule. In this method, dependency of a light incident angle and a sample concentration upon intensity of light scattering light is determined and analyzed by e.g., the Zimm method or the Berry method. Owing to this, the molecular weight close to a real molecular weight (absolute molecular weight) can be determined with respect to all molecular forms including a linear polymer and a branched polymer. In the present invention, the intensity of light scattering light is measured by the SEC-MALLS measurement (as described later) and the following relationship expressed by the Zimm method is analyzed by use of Debye Plot. In this way, the weight average molecular weight (Mw) and inertial square radius (Rg²) based on the absolute molecular weight were obtained. Note that the Debye Plot is a graph, the vertical axis of which indicates K·C/R(θ) and the horizontal axis of which indicates sin²(θ/2). The weight average molecular weight (Mw) is calculated from the intercept of the vertical axis and the inertial square radius (Rg²) can be calculated from the slope.

However, the Mw and Rg² calculated above are values of each component per elution time. Thus, in order to obtain Mw and Rg² of a whole sample, an average of each of the values must be further calculated.

Note that when measurement is performed by an apparatus (described later), the weight average molecular weight (Mw) and average rotation radius (Rw) of the whole sample can be directly output from the apparatus.

$$\frac{K \cdot C}{R ( θ )} = \frac{1}{Mw} \cdot \frac{1}{P ( θ )} = \frac{1}{Mw} [ 1 + 〈 {Rg}^{2} 〉 {sin}^{2} ( \frac{θ}{2} ) \cdot 16 {π}^{2} / 3 {λ}^{2} ] \qquad Zimm Equation$$

K: Optical constant

C: Concentration of polymer (g/mL)

R(θ): Relative intensity of scattered light at a scattering angle θ

Mw: Weight average molecular weight

P(θ): Factor indicating angle-dependency of scattered light

<Rg²>: Inertial square radius

λ: Wavelength (nm) of laser light in solution

In the present invention, it is important that the weight average molecular weight (Mw) determined by size exclusion chromatography multi-angle scattering (SEC-MALLS) measurement is 5000 or more and 20000 or less. If the weight average molecular weight (Mw) is 20000 or less, viscosity can be reduced when heat is applied to a magnetic toner. Consequently, the toner is easily melted in fixing and low-temperature fixability is improved. In contrast, if the weight average molecular weight (Mw) is 5000 or more, the elasticity of a magnetic toner increases, with the result that the stabilization during long-time use can be improved.

In the magnetic toner of the present invention, as mentioned above, the ratio of the average rotation radius (Rw) to the weight average molecular weight (Mw) [Rw/Mw] is 3.0×10⁻³ or more and 6.5×10⁻³ or less and preferably 5.0×10⁻³ or more and 6.5×10⁻³ or less.

The Rw/Mw of 3.0×10⁻³ or more means that the molecular structure is linear. In this case, as described above, the sharp melting properties improve. As a result, low-temperature fixability can be improved. Particularly, if the Rw/Mw is 5.0×10⁻³ or more, it is preferable because the sharp melting properties can be easily improved.

If the Rw/Mw is 6.5×10⁻³ or less, satisfactory image density can be obtained during long-time use.

Note that the above weight average molecular weight (Mw) can be controlled to fall within the aforementioned range by adjusting the type and addition amount of polymerization initiator, polymerization reaction temperature and the concentration of a vinyl monomer in a dispersion medium during a polymerization reaction.

In contrast, Rw/Mw can be controlled to fall within the aforementioned range by adjusting e.g., the type and addition amount of polymerization initiator, polymerization reaction temperature, the concentration of a vinyl monomer in a dispersion medium during a polymerization reaction and the type and addition amount of chain transfer agent and by adding a polymerization inhibitor.

As the chain transfer agent, a chain transfer agent known in the art can be used. Examples thereof include mercaptans such as t-dodecyl mercaptan, n-dodecyl mercaptan and n-octyl mercaptan; and halogenated hydrocarbons such as carbon tetrachloride and carbon tetrabromide. These chain transfer agents each can be added before or in the middle of polymerization. The addition amount of chain transfer agent is preferably 0.001 to 10 parts by mass relative to a vinyl monomer (100 parts by mass) and more preferably 0.1 to 5 parts by mass.

In the present invention, the viscosity of a magnetic toner measured at 110° C. measured by a flow tester temperature increasing method is 5000 Pa·s or more and 25000 Pa·s or less. The viscosity thereof at 110° C. is preferably 5000 Pa·s or more and 20000 Pa·s or less.

Through the studies conducted by the present inventors, it was found that the viscosity of a magnetic toner (of the physical properties of the magnetic toner) at a high temperature of 100° C. or more is correlated with the offset properties. Of them, film fixation, which is a preferable fixing method of the present invention, was confirmed to correlate with the viscosity at 110° C. When the temperature of 110° C. is applied to the fixing step, it conceivably corresponds to the temperature of the magnetic toner at the fixing nip and/or the temperature when release is made from the fixing film after passing through the fixing nip.

If the viscosity at 110° C. is 25000 Pa·s or less, melting/ plasticizing /deformation of a magnetic toner at the fixing nip can be attained, fixability is improved to improve offset resistance.

If the viscosity at 110° C. is 5000 Pa·s or more, the viscosity of a magnetic toner itself is relatively high. Accordingly, the magnetic toner is sufficiently adhered to a medium such as paper and thus easily released from a fixing film after it passes through a fixing nip. As a result, offset resistance is improved.

Note that the viscosity at 110° C. can be controlled to fall within the aforementioned range by adjusting the weight average molecular weight (Mw) of a binder resin, the ratio of the average rotation radius (Rw) to the weight average molecular weight (Mw) [Rw/Mw] and the type and addition amount of release agent.

It is characterized in that the binder resin of the magnetic toner of the present invention is a styrene resin. If a styrene resin is used as the binder resin, the ratio [Rw/Mw], which serves as an index of the degree of branching, can be easily adjusted within a desired range.

Specific examples of the styrene resin include styrene copolymers such as polystyrene, a styrene-propylene copolymer, a styrene-vinyl toluene copolymer, a styrene-methyl acrylate copolymer, a styrene-ethyl acrylate copolymer, a styrene-butyl acrylate copolymer, a styrene-octyl acrylate copolymer, a styrene-methyl methacrylate copolymer, a styrene-ethyl methacrylate copolymer, a styrene-butyl methacrylate copolymer, a styrene-octyl methacrylate copolymer, a styrene-butadiene copolymer, a styrene-isoprene copolymer, a styrene-maleic acid copolymer and a styrene-maleate copolymer. These can be used alone or in combination with a plurality of types.

Of them, particularly, a styrene-butyl acrylate copolymer and a styrene-butyl methacrylate copolymer can be used because the degree of branching and resin viscosity are easily adjusted, with the result that developability, fixability and offset resistance can be obtained at the same time.

The binder resin to be used in the magnetic toner of the present invention is a styrene resin; however, the following resins can be used in combination as long as the advantageous effects of the invention are not damaged.

Examples of the resins include a polymethyl methacrylate, a poly(butyl methacrylate), a polyvinyl acetate, a polyethylene, a polypropylene, a poly (vinyl butyral), a silicone resin, a polyester resin, a polyamide resin, an epoxy resin and a polyacrylic resin. These can be used alone or in combination with a plurality of types.

As the monomer for producing the above styrene resin, the following monomers are mentioned:

styrene; styrene derivatives such as o-methylstyrene, m-methylstyrene, p-methylstyrene, p-methoxystyrene, p-phenylstyrene, p-chlorostyrene, 3,4-dichlorostyrene, p-ethylstyrene, 2,4-dimethylstyrene, p-n-butylstyrene, p-tert butylstyrene, p-n hexylstyrene, p-n octylstyrene, p-n nonylstyrene, p-n decylstyrene and p-n dodecylstyrene; unsaturated monoolefins such as ethylene, propylene, butylene and isobutylene; unsaturated polyenes such as butadiene and isoprene; halogenated vinyls such as vinyl chloride, vinylidene chloride, vinyl bromide and vinyl fluoride; vinyl esters such as vinyl acetate, vinyl propionate and vinyl benzoate; a-methylene aliphatic monocarboxylic acid esters such as methyl methacrylate, ethyl methacrylate, propyl methacrylate, n butyl methacrylate, isobutyl methacrylate, n octyl methacrylate, dodecyl methacrylate, 2-ethylhexyl methacrylate, stearyl methacrylate, phenyl methacrylate, dimethylaminoethyl methacrylate and diethylaminoethyl methacrylate; acrylic acid esters such as methyl acrylate, ethyl acrylate, n butyl acrylate, isobutyl acrylate, propyl acrylate, n octyl acrylate, dodecyl acrylate, 2-ethylhexyl acrylate, stearyl acrylate, 2-chloroethyl acrylate and phenyl acrylate; vinyl ethers such as vinyl methyl ether, vinyl ethyl ether and vinyl isobutyl ether; vinyl ketones such as vinyl methyl ketone, vinyl hexyl ketone and methyl isopropenyl ketone; N-vinyl compounds such as N-vinylpyrrole, N-vinylcarbazole, N-vinylindole and N-vinylpyrrolidone; vinyl naphthalines; and acrylic or methacrylic acid derivatives such as acrylonitrile, methacrylonitrile and acryl amide.

Examples thereof further include unsaturated dibasic acids such as maleic acid, citraconic acid, itaconic acid, alkenylsuccinic acid, fumaric acid and mesaconic acid; unsaturated dibasic anhydrides such as maleic anhydride, citraconic anhydride, itaconic anhydride and alkenylsuccinic anhydride; unsaturated dibasic half esters such as methyl maleic acid half ester, ethyl maleic acid half ester, butyl maleic acid half ester, methyl citraconic acid half ester, ethyl citraconic acid half ester, butyl citraconic acid half ester, methyl itaconic acid half ester, methyl alkenylsuccinic acid half ester, methyl fumaric acid half ester and methyl mesaconic acid half ester; unsaturated dibasic acid esters such as dimethyl maleate, and dimethyl fumarate; α,β-unsaturated acids such as acrylic acid, methacrylic acid, crotonic acid and cinnamic acid; α,β-unsaturated acid anhydrides such as crotonic anhydride and cinnamic anhydride; anhydrides between the α,β-unsaturated acid and a lower fatty acid; and monomers having a carboxyl group such as alkenylmalonic acid, alkenylglutaric acid, alkenyladipic acid, anhydrides of these and monoesters of these.

Examples thereof further include acrylates or methacrylates such as 2-hydroxyethyl acrylate, 2-hydroxyethyl methacrylate and 2-hydroxypropyl methacrylate; and monomers having a hydroxy group such as 4-(1-hydroxy-l-methylbutyl)styrene and 4-(1-hydroxy-1-methylhexyl) styrene.

In the magnetic toner of the present invention, a styrene resin to be used as a binder resin may have a crosslinked structure crosslinked with a crosslinking agent having two or more vinyl groups. As the crosslinking agent to be used herein, the following agents are mentioned:

Aromatic divinyl compounds such as divinylbenzene and divinyl naphthalene;

Diacrylate compounds connected via an alkyl chain, such as ethylene glycol diacrylate, 1,3-butylene glycol diacrylate, 1,4-butanediol diacrylate, 1,5-pentanediol acrylate, 1,6-hexanediol acrylate and neopentylglycol diacrylate and compounds prepared by replacing an acrylate of the above compounds with a methacrylate;

Diacrylate compounds connected via an alkyl chain containing an ether bond, such as diethylene glycol diacrylate, triethylene glycol diacrylate, tetraethylene glycol diacrylate, polyethylene glycol #400 diacrylate, polyethylene glycol #600 diacrylate, dipropylene glycol diacrylate and compounds prepared by replacing an acrylate of the above compounds with a methacrylate;

Diacrylate compounds connected via a chain containing an aromatic group and an ether bond, such as (2)-2,2-bis(4-hydroxyphenyl)propane diacrylate, polyoxyethylene (4)-2,2-bis(4-hydroxyphenyl)propane diacrylate, and compounds prepared by replacing an acrylate of the above compounds with a methacrylate;

Polyester diacrylate compounds such as MANDA (trade name, manufactured by Nippon Kayaku Co., Ltd.); and

Multifunctional crosslinking agents such as pentaerythritol triacrylate, trimethylolethane triacrylate, trimethylolpropane triacrylate, tetramethylolmethane tetraacrylate, oligoester acrylate and compounds prepared by replacing an acrylate of the above compounds with a methacrylate; and triallyl cyanurate and triallyl trimellitate.

The use amounts of crosslinking agents is preferably 0.01 to 10 parts by mass and further preferably 0.03 to 5 parts by mass relative to other monomer components (100 parts by mass).

Of these crosslinkable monomers, as a monomer that can be used in a binder resin in view of fixability and offset resistance, an aromatic divinyl compound (particularly divinyl benzene) and a diacrylate compound connected by a chain containing an aromatic group and an ether bond are mentioned.

Examples of the polymerization initiator to be used in producing a styrene resin as mentioned above include 2,2′-azobisisobutyronitrile, 2,2′-azobis(4-methoxy-2,4-dimethylvaleronitrile), 2,2′-azobis(2,4-dimethylvaleronitrile), 2,2′-azobis(2-methylbutyronitrile), dimethyl-2,2′-azobisisobutylate, 1,1′-azobis(1-cyclohexanecarbonitrile), 2-(carbamoylazo)-isobutyronitrile, 2,2′-azobis(2,4,4-trimethylpentane), 2,-phenylazo-2,4-dimethyl-4-methoxyvaleronitrile, 2,2-azobis(2-methylpropane), ketone peroxides such as methyl ethyl ketone peroxide, acetyl acetone peroxide and cyclohexanone peroxide; 2,2-bis(t-butylperoxy)butane, t-butyl hydroperoxide, cumen hydroperoxide, 1,1,3,3-tetramethylbutyl hydroperoxide, di-t-butyl hydroperoxide, t-butylcumyl peroxide, dicumyl peroxide, α,α′-bis(t-butylperoxyisopropyl) benzene, isobutyl peroxide, octanoyl peroxide, decanoyl peroxide, lauroyl peroxide, 3,5,5-trimethylhexanoyl peroxide, benzoyl peroxide, m-trioyl peroxide, diisopropyl peroxydicarbonate, di-2-ethylhexyl peroxydicarbonate, di-n-propyl peroxydicarbonate, di-2-ethoxyethyl peroxycarbonate, dimethoxyisopropyl peroxydicarbonate, di(3-methyl-3-methoxybutyl)peroxycarbonate, acetylcyclohexyl sulfonylperoxide, t-butyl peroxyacetate, t-butyl peroxyisobutylate, t-butyl peroxyneodecanoate, t-butyl peroxy-2-ethylhexanoate, t-butyl peroxylaurate, t-butyl peroxybenzoate, t-butyl peroxyisopropylcarbonate, di-t-butyl peroxyisophthalate, t-butyl peroxyallylcarbonate, t-amyl peroxy-2-ethyhexanoate, di-t-butyl peroxyhexahydroterephthalate and di-t-butyl peroxyazelate.

The binder resin according to the present invention preferably has a glass transition temperature (Tg) of 40° C. to 70° C. and more preferably 50° C. to 70° C., since low-temperature fixability and storage stability are simultaneously attained. If Tg is 40° C. or more, storage stability easily improves. If Tg is 70° C. or less, it is preferable since low-temperature fixability tends to improve.

In the magnetic toner of the present invention, the external additives and conditions of adding the external additives should satisfy the requirements, which will be summarized below.
A first inorganic fine particle and an organic-inorganic composite fine particle are present.
The organic-inorganic composite fine particle has a structure in which a second inorganic fine particle is embedded in a vinyl resin particle, a vinyl resin component constituting the vinyl resin particle contains THF-insoluble matter in an amount of 95 mass % or more.
The content of the organic-inorganic composite fine particle is 0.5 mass % or more and 3.0 mass % or less based on the mass of the toner particle.
The first inorganic fine particle contains at least one inorganic oxide fine particle selected from the group consisting of silica fine particle, titanium oxide fine particle and alumina fine particle, with the proviso that the inorganic oxide fine particle contains silica fine particle in amount of 85 mass % or more based on the total mass of the inorganic oxide fine particle, and
The first inorganic fine particle has a number-average particle diameter (Dl) of 5 nm or more and 25 nm or less.
The coverage ratio A of the toner-particle surface with the first inorganic fine particle is 45.0% or more and 70.0% or less.

It was found that owing to the above constitution of the magnetic toner of the present invention, fixability and end-portion offset properties can be simultaneously obtained while maintaining stability during long-time use. The present inventors consider the reason as follows.

Conventionally, to suppress deterioration during long-term use, spacer particles have been used. These spacer particles are effective against embedment of external additives; however, it has become clear that the effect decreases since the spacer particles receive excessive stress and moves to concaves of toner base particles in accordance with increasing the number of sheets in the image formation. In contrast, the studies conducted by the present inventors elucidated that the effect of spacer particles can be maintained up to the latter half of the duration test by controlling the shape of the spacer particles to increase adhesion to the toner base particles. In addition, it was elucidated that the spacer particles controlled in shape exert a higher effect on a toner surface if the toner surface is more widely coated with inorganic fine particles than if coated with conventional inorganic fine particles. This is presumably because the height of convexes and the depth of concaves in the surface of the magnetic toner are reduced by the coating with the inorganic fine particles.

In the magnetic toner of the present invention, the molecular weight and the degree of branching are controlled to reduce viscosity in melting. However, the molecular weight is larger than that of a conventional toner, which is reduced in molecular weight and glass transition temperature to attain low viscosity. The degree of branching of the magnetic toner is linear but the molecular weight is large. Thus, the intensity of the magnetic toner is improved in the range of a glass transition temperature or less of the magnetic toner compared to the conventional magnetic toner reduced in molecular weight. Because of this, deterioration of the toner rarely occurs even if the toner is used for a long-time and stability of images is improved. Also in order to easily control elasticity of such a toner particle surface reduced in viscosity, the organic-inorganic composite fine particle is said to be more preferable than the inorganic fine particle conventionally used.

Using such an organic-inorganic composite fine particle is used, the relationship between the coverage ratio of the surface of the magnetic toner particle with the first inorganic fine particle and the coverage ratio of the surface of the magnetic toner particle with first inorganic fine particle adhered to the surface, is defined. In addition, the molecular weight and the degree of branching of the magnetic toner are defined. Accordingly, it is presumed that the toner which rarely deteriorates even if the toner is used for long-time can be obtained and stabilization of images can be attained.

Now, the magnetic toner of the present invention will be more specifically described.

It is characterized in that the toner of the present invention employs a first inorganic fine particle and an organic-inorganic composite fine particle in combination. This is an essential constitution in order to suppress deterioration of the toner until an operation reaches the latter half of a duration test, as described above. Use of the first inorganic fine particle is essential to more efficiently obtain the effect of the spacer. It is characterized in that the organic-inorganic composite fine particle to be used in the present invention is constituted of a second inorganic fine particle embedded in a vinyl resin particle, and that a vinyl resin component constituting the vinyl resin particle contains THF-insoluble matter in an amount of 95 mass % or more. In order to control of adhesion force to a first inorganic fine particle coating the toner surface and provide an elastic component to the toner surface, it is preferable that the organic-inorganic composite fine particle is constituted of a second inorganic fine particle embedded in a vinyl resin particle. In the case of an organic fine particle, the adhesion force to the toner surface decreases, with the result that developability may reduce in the latter half of a duration test; whereas in the case of an inorganic fine particle, elasticity cannot be efficiently given, with the result that the end-portion offset resistance tends to decrease.

In the vinyl resin component constituting the vinyl resin particle, if the amount of THF-insoluble matter is less than 95 mass %, the elasticity of a toner surface cannot be efficiently controlled and end-portion offset resistance tends to decrease.

It is preferable that the organic-inorganic composite fine particle to be used in the present invention has a plurality of convexes on its surface due to the presence of a second inorganic fine particle. This is a preferable embodiment in order to control adhesion force to the toner surface. The number average diameter of the organic-inorganic composite fine particle is preferably 50 nm or more and 200 nm or less in order to suppress variation in durability and end-portion offset. If the number average diameter falls within the range, reduction in developability and occurrence of end-portion offset in the latter half of a duration test can be suppressed without fail.

It is characterized in that the content of the organic-inorganic composite fine particle is 0.5 mass % or more and 3.0 mass % or less based on the mass of the toner particle (in other words, 0.5 parts by mass or more and 3.0 parts by mass or less based on 100 parts by mass of the toner particle). This is an essential addition amount in order to control elasticity of a toner surface and exert a deterioration suppression effect during the latter half of a duration test. If the content is less than 0.5 mass %, developability reduces and end-portion offset occurs in the latter half of a duration test. In contrast, if the content is more than 3.0 mass %, the toner surface becomes excessively elastic and low-temperature fixability tends to reduce.

The organic-inorganic composite fine particle can be produced, for example, according to the description of Examples of WO 2013/063291. The second inorganic fine particle to be used in organic-inorganic composite fine particle is not particularly limited; however, at least one inorganic oxide particle selected from the group consisting of silica, titanium oxide and alumina is preferable in view of adhesion to a toner surface in the present invention.

Provided that the coverage ratio of a magnetic toner-particle surface with the first inorganic fine particle is represented by coverage ratio A (%), it is characterized in that the magnetic toner of the present invention has coverage ratio A of 45.0% or more and 70.0% or less.

Since the magnetic toner of the present invention has coverage ratio A as high as 45.0% or more, the van der Waals force between the magnetic toner and a member is low. As a result, the adhesion force between magnetic toner and between magnetic toner and the member tend to reduce and thus stabilization of images during long-time use can be improved. In addition, it is also effective to reduce the number of small convexes and concaves of the toner surface.

In contrast, if coverage ratio A is 70.0% or less, the above effect can be obtained without inhibiting low-temperature fixability.

Provided that the coverage ratio with first inorganic fine particle adhered to the surface of a magnetic toner particle is represented by coverage ratio B (%) in the magnetic toner of the present invention, the ratio of coverage ratio B to coverage ratio A [coverage ratio B/coverage ratio A, hereinafter simply referred also to B/A] is preferably 0.50 or more and 0.85 or less.

Coverage ratio A is a coverage including a first inorganic fine particle that can be easily liberated; whereas, coverage ratio B is a coverage ratio with a first inorganic fine particle which is adhered to the surface of a magnetic toner particle and would not be removed by the removal operation (described later). The first inorganic fine particle involved in coverage ratio B is adhered, in a half-embedded state, to the surface of a magnetic toner particle and conceivably unmoved even if shear force is applied to the magnetic toner on a development sleeve and an electrostatic latent image carrier.

In the first inorganic fine particle involved in coverage ratio A, the inorganic fine particle, which is adhered to the toner particle, and first inorganic fine particle, which is present above the adhered first inorganic fine particle and has relatively high degree of freedom, are included.

The ratio of B/A of 0.50 or more and 0.85 or less means that the first inorganic fine particle adhered to the surface of a magnetic toner is present to some extent, and the easily removable first inorganic fine particle (that can be behave separately from the magnetic toner particle) is present above the adhered first inorganic fine particle in an appropriate amount. It is considered that a bearing effect is probably produced by slippage of removable first inorganic fine particle over the adhered first inorganic fine particle, with the result that the aggregation force between magnetic toner particles significantly decreases. Thus, as described above, the surface of an unfixed image can be smooth and close to be highly dense. As a result, heat from a fixing unit can be uniformly and efficiently applied to a magnetic toner. In addition, since excessive stress to the magnetic toner is eliminated by the bearing effect, image stability is significantly improved in long-time use.

As the results of studies conducted by the present inventors, the adhesion-force reducing effect and bearing effect can be effectively obtained by the constitution where the adhered first inorganic fine particle and easily removable first inorganic fine particle both are relatively small inorganic fine particles having a primary-particle number average particle diameter (Dl) of about 50 nm or less and a spacer particle having a predetermined particle diameter is present. Thus, when coverage ratio A and coverage ratio B were calculated, focus was placed on a first inorganic fine particle having a primary-particle number average particle diameter (Dl) of 50 nm or less.

In the present invention, the variation coefficient of coverage ratio A is preferably 10.0% or less and more preferably 8.0% or less. The variation coefficient of 10.0% or less means that extremely uniform coverage ratio A is obtained between magnetic toner particles and within a magnetic toner particle.

If the variation coefficient of coverage ratio A is 10.0% or less, it is preferable since an adhered first inorganic fine particle can be present more uniformly on the surface of a fixed image after passing through a fixing nip, as described above, with the result that the release properties of a magnetic toner from a fixing film can be more efficiently provided.

If the variation coefficient of coverage ratio A exceeds 10.0%, the coating states of the magnetic-toner surfaces is not uniform, with the result that aggregation force between toner particles rarely reduces.

A technique for controlling the variation coefficient of coverage ratio A to be 10.0% or less is not particularly limited, an apparatus and a technique for adding external additives capable of highly dispersing a metal oxide fine particle such as a silica fine particle on the surface of a magnetic toner particle can be used.

The coverage ratio of a first inorganic fine particle can be theoretically calculated according to a calculation expression described in e.g., PTL 2, based on the assumption that a first inorganic fine particle and a magnetic toner are true spherical. However, there are many cases where a first inorganic fine particle and a magnetic toner are not true spherical. In addition, a first inorganic fine particle may be present as an aggregate on the surface of a toner particle. Theoretical coverage ratios obtained in such a technique are irrelevant to the present invention.

The present inventors obtained the coverage ratio of a first inorganic fine particle actually covering the magnetic-toner surface by observing the surface of a magnetic toner by a scanning electron microscope (SEM).

As an example, mixtures were prepared by adding a silica fine particle in different amounts (the number of parts of silica particles added) relative to 100 parts by mass of a magnetic toner particle (containing a magnetic substance in a content of 43.5 mass %) having a volume average particle diameter (Dv) of 8.0 μm and obtained by a grinding method. Then, theoretical coverage ratios and actual coverage ratios of these mixtures were obtained. Note that the silica fine particle used herein had a volume average particle diameter (Dv) of 15 nm.

Furthermore, in calculating a theoretical coverage ratio, the true-specific gravity of a silica fine particle was regarded as 2.2 g/cm³, and the true-specific gravity of a magnetic toner was regarded as 1.65 g/cm³, and the silica fine particle and magnetic toner particle were regarded as mono-dispersed particles having a particle diameter of 15 nm and 8.0 respectively.

According to the studies conducted by the present inventors, it was found that even if the addition amount of silica fine particle is equivalent, the coverage ratio changes depending upon the technique of adding the external additives. In other words, the coverage ratio of a silica fine particle cannot be simply obtained solely based on the addition amount thereof. For the reason, the present inventors employed the coverage ratio with a first inorganic fine particle obtained by SEM observation of a magnetic-toner surface.

In summary, in the present invention, an organic-inorganic composite fine particle having a predetermined shape and predetermined THF-insoluble matter is added in a proper amount and the coverage ratio with an adhered first inorganic fine particle is controlled. In this manner, a smooth surface of an unfixed image is obtained. This is considered that a magnetic toner (not yet fixed) is mounted on a medium such as paper in an almost closest packing state. The unfixed image has high sharp-melting properties, since it can receive uniformly and efficiently heat from a fixing unit and exhibits low viscosity in melting because the molecular weight and branching degree of a magnetic toner are controlled. Besides this, since the composite fine particle having elasticity is present on the surface of the unfixed image, the release properties of the magnetic toner from a fixing film remarkably improve. Since the above effects work synergistically, end-portion offset properties are conceivably improved while keeping durability even in high-speed printing.

In the present invention, examples of a magnetic substance to be contained in a magnetic toner include iron oxides such as magnetite, maghemite and ferrite, metals such as iron, cobalt and nickel, alloys of these metals with a metal such as aluminium, copper, magnesium, tin, zinc, beryllium, calcium, manganese, selenium, titanium, tungsten and vanadium, and mixtures of these.

The particle of the magnetic substance preferably has a primary-particle number average particle diameter (D1) of 0.50 μm or less and more preferably 0.05 μm to 0.30

The magnetic substance preferably has the following magnetic properties under application of 795.8 kA/m: a coercive force (Hc) of 1.6 to 12.0 kA/m, an intensity of magnetization (σs) of 50 to 200 Am²/kg and more preferably 50 to 100 Am²/kg, and a residual magnetization (σr) of 2 to 20 Am²/kg.

The magnetic toner of the present invention contains a magnetic substance in an amount of preferably 35 mass % or more and 50 mass % or less, and more preferably 40 mass % or more and 50 mass % or less.

If the content of a magnetic substance in the magnetic toner is less than 35 mass %, magnetic attractive force to a magnet roll within a development sleeve reduces and fogging tends to occur.

In contrast, if the content of a magnetic substance exceeds 50 mass %, developability tends to reduce.

The content of a magnetic substance in a magnetic toner can be measured by e.g., a thermal analysis apparatus, TGA Q5000IR, manufactured by PerkinElmer Co., Ltd. Measurement is performed by heating a magnetic toner at a temperature increasing rate of 25° C./minute from normal temperature to 900° C. under a nitrogen atmosphere. A reduction in mass of the magnetic toner by a temperature change from 100 to 750° C. is obtained and regarded as the mass of components of the magnetic toner excluding the magnetic substance. The remaining mass is determined as the amount of magnetic substance.

In the magnetic toner of the present invention, a charge control agent can be added. Note that the magnetic toner of the present invention can be a toner that can be negatively charged.

As a charge control agent for negative charge use, an organic metal complex and a chelate compound are effectively used. Examples thereof include monoazometal complexes; acetyl acetone metal complexes; and metal complexes of an aromatic hydroxycarboxylic acid or an aromatic dicarboxylic acid.

Specific examples of a commercially available product thereof include Spilon Black TRH, T-77, T-95 manufactured by Hodogaya Chemical Co., LTD.) and BONTRON (R) S-34, S-44, S-54, E-84, E-88, E-89 (manufactured by Orient Chemical Industries Co., Ltd).

These charge control agents can be used alone or in combination of two or more. Use amount of these charge control agents is preferably 0.1 to 10.0 parts by mass and more preferably 0.1 to 5.0 parts by mass based on the binder resin (100 parts by mass), in view of the charge amount of magnetic toner.

The magnetic toner of the present invention can contain a release agent. As the release agent, a hydrocarbon wax such as a low molecular weight polyethylene, a low molecular weight polypropylene, microcrystalline wax and paraffin wax can be used in view of dispersibility in a magnetic toner and high release properties.

The reason why a hydrocarbon wax is preferable is as follows. Since the hydrocarbon wax tends to have lower compatibility with a binder resin than an ester wax, the hydrocarbon wax is rarely melted with a binder resin in melting for fixation, with the result that the release properties easily produced. As a result, the release properties of a magnetic toner from a fixing film improve and low-temperature offset rarely occurs.

If necessary, one or two or more types of the following waxes may be used in combination in a small amount. Examples of the waxes include:

Oxides of aliphatic hydrocarbon waxes such as polyethylene oxide waxes or block copolymers of these; wax containing a fatty acid ester as a main component such as carnauba wax, sasol wax and montanic acid ester wax; and waxes obtained by partially or wholly deoxidizing fatty acid esters such as deoxidized carnauba wax. Other examples of these include saturated linear fatty acids such as palmitic acid, stearic acid, and montanic acid; unsaturated fatty acids such as brassidic acid, eleostearic acid and parinaric acid; saturated alcohols such as stearyl alcohol, aralkyl alcohol, behenyl alcohol, carnaubyl alcohol, ceryl alcohol and melissyl alcohol; long-chain alkyl alcohols; polyhydric alcohols such as sorbitol; fatty acid amides such as linoleic amide, oleic amide and lauric amide; saturated fatty acid bisamides such as methylenebis stearic amide, ethylenebis capric amide, ethylenebis lauric amide and hexamethylenebis stearic amide; unsaturated fatty acid amides such as ethylenebis oleic amide, hexamethylenebis oleic amide, N,N′-dioleoyladipic amide and N,N-dioleoylsebacic amide; aromatic bisamides such as m-xylenebis stearic amide, N,N-distearyl isophthalic amide; fatty acid metal salts (generally called as metal soaps) such as calcium stearate, calcium laurate, zinc stearate and magnesium stearate; waxes obtained by grafting by using a vinyl monomer such as styrene or acrylic acid to aliphatic hydrocarbon waxes; esters obtained by partially esterifying a polyhydric alcohol with a fatty acid such as behenic acid monoglyceride; and methyl ester compounds having a hydroxyl group, obtained by e.g., hydrogenation of a vegetable fat and oil.

Furthermore, the melting point of the release agent, which is defined by the peak temperature of a maximum endothermic peak during temperature raising and measured by a differential scanning calorimeter (DSC), is preferably 60 to 140° C. and more preferably 60 to 90° C. If the melting point is 60° C. or more, it is preferable since the viscosity of a magnetic toner can be easily adjusted within the range of the present invention. In contrast, if the, melting point is 140° C. or less, it is preferable since low-temperature fixability can be easily improved.

The content of a release agent as mentioned above is preferably 0.1 to 20 parts by mass and more preferably 0.5 to 10 parts by mass based on a binder resin (100 parts by mass).

If the content of a release agent is 0.1 part by mass or more, release from a fixing film can be easily made and low-temperature offset resistance can be easily improved. In contrast, if the content of a release agent is 20 parts by mass or less, deterioration of the magnetic toner rarely occurs during long-time use and image stability can be easily improved.

Furthermore, such a release agent can be added to a binder resin in producing the resin (by dissolving the resin in a solvent and increasing the temperature of the resin solution) by adding the release agent thereto while stirring or in producing a toner by adding the release agent during melt-kneading.

In the magnetic toner of the present invention, a first inorganic fine particle is present on the surface of a particle of the magnetic toner.

Examples of the first inorganic fine particle present on the surface of a magnetic toner particle include a silica fine particle, a titania fine particle and an alumina fine particle. These fine particles to the surface of which a hydrophobic treatment is applied can be suitably used.

In the present invention, the first inorganic fine particle present on the surface of a magnetic toner particle contains at least one metal oxide fine particle selected from the group consisting of a silica fine particle, a titania fine particle and an alumina fine particle. It is important that 85 mass % or more of the metal oxide fine particle is a silica fine particle. It is preferable that 90 mass % or more of the metal oxide fine particle is a silica fine particle. This is because a silica fine particle is the most excellent in balance in order to provide electrostatic properties and flowability as well as excellent in reducing aggregation force between toner particles.

The reason why a silica fine particle is excellent in reducing aggregation force between toner particles is not clear, however, a bearing effect as mentioned above produced by slippage between silica fine particles is presumed to significantly work.

It is preferable that the first inorganic fine particle adhered to the surface of a magnetic toner particle contains a silica fine particle as a main component. More specifically, the first inorganic fine particle adhered to the surface of a magnetic toner particle contains at least one metal oxide fine particle selected from a silica fine particle, a titania fine particle and an alumina fine particle. It is preferable that 80 mass % or more of the metal oxide fine particle is a silica fine particle, and more preferably 90 mass % or more of the metal oxide fine particle is silica fine particle. The reason is presumably the same as above. In order to provide electrostatic properties and flowability, silica fine particle is the most excellent. Owing to the silica fine particle, a magnetic toner is charged quickly upon staring-up. As a result, a high image density can be obtained. Thus, use of a silica fine particle is extremely preferable.

Herein, in order to contain a silica fine particle in an amount of 85 mass % or more based on a metal oxide fine particle present in the surface of a magnetic toner particle and in an amount of 80 mass % or more based on the metal oxide particle adhered to the surface of a magnetic toner particle, the amount and timing of adding a first inorganic fine particle can be adjusted.

The presence amount of a first inorganic fine particle can be determined by a quantification method (described later).

In the present invention, it is preferable that a primary-particle number average particle diameter (D1) of a first inorganic fine particle is 5 nm or more and 50 nm or less.

If the primary-particle number average particle diameter (D1) of a first inorganic fine particle falls within the above range, coverage ratio A and B/A can be properly controlled. If the primary-particle number average particle diameter (D1) of a first inorganic fine particle falls within the above range, the adhesion force significantly reduces and a significant bearing effect is obtained.

It is preferable that the first inorganic fine particle to be used in the present invention is hydrophobically treatment in advance. Particularly preferably, a hydrophobic treatment is performed such that the degree of hydrophobicity measured by a methanol titration test becomes 40% or more, and more preferably 50% or more.

As the hydrophobic treatment method, for example, a treatment method with an organo-silicon compound, a silicone oil or a long-chain fatty acid is mentioned.

Examples of the organo-silicon compound include hexamethyldisilazane, trimethylsilane, trimethylethoxysilane, isobutyltrimethoxysilane, trimethylchlorosilane, dimethyldichlorosilane, methyltrichlorosilane, dimethylethoxysilane, dimethyldimethoxysilane, diphenyldiethoxysilane and hexamethyldisiloxane. These can be used alone or as a mixture of one or two or more.

Examples of the silicone oil include a dimethylsilicone oil, a methylphenylsilicone oil, an a-methylstyrene modified silicone oil, a chlorophenyl silicone oil and a fluorine modified silicone oil.

As the long-chain fatty acid, a fatty acid having 10 to 22 carbon atoms is preferably used. The long-chain fatty acid may be a linear-chain fatty acid or a branched fatty acid. Either a saturated fatty acid or an unsaturated fatty acid can be used.

Of them, a linear saturated fatty acid having 10 to 22 carbon atoms is extremely preferable since the surface of an inorganic fine particle can be uniformly treated.

Examples of the linear saturated fatty acid include capric acid, lauric acid, myristic acid, palmitic acid, stearic acid, arachic acid and behenic acid.

As the first inorganic fine particle to be used in the present invention, first inorganic fine particle treated with a silicone oil is preferable, and first inorganic fine particle treated with an organo-silicon compound and a silicone oil is more preferable. This is because the degree of hydrophobicity can be preferably controlled.

As a method for treating the first inorganic fine particle with silicone oil, for example, a method of directly adding first inorganic fine particle treated with an organo-silicon compound to a silicone oil and mixing them by a mixer such as a Henschel mixer, and a method of spraying silicone oil to first inorganic fine particle are mentioned. Alternatively, a method of dissolving or dispersing a silicone oil in an appropriate solvent, thereafter adding a first inorganic fine particle thereto, mixing it and removing the solvent may be mentioned.

To obtain satisfactory hydrophobicity, the amount of silicone oil for treatment is preferably 1 part by mass or more and 40 parts by mass or less relative to the first inorganic fine particle (100 parts by mass), and more preferably 3 parts by mass or more and 35 parts by mass or less.

The silica fine particle, titania fine particle and alumina fine particle to be used in the present invention preferably has a specific surface area (BET specific surface area, measured by BET method based on nitrogen adsorption) of 20 m²/g or more and 350 m²/g or less and more preferably 25 m²/g or more and 300 m²/g or less, in order to obtain satisfactory flowability of a magnetic toner.

The specific surface area (BET specific surface area, measured by the BET method based on nitrogen adsorption) is measured according to JIS Z 8830 (2001). As the measurement apparatus, an “automatic specific surface area/fine pore distribution measurement apparatus, TriStar 3000 (manufactured by Shimadzu Corporation)” employing a gas adsorption method (based on a constant volume method) as the measurement system, is used.

Herein, the addition amount of a first inorganic fine particle, is preferably 1.5 parts by mass or more and 3.0 parts by mass or less relative to the magnetic toner particle (100 parts by mass), more preferably 1.5 parts by mass or more and 2.6 parts by mass or less, and further preferably 1.8 parts by mass or more and 2.6 parts by mass or less.

If the addition amount of a first inorganic fine particle falls within the above range, coverage ratio A and B/A can be easily controlled. If the addition amount of a first inorganic fine particle exceeds 3.0 parts by mass, a first inorganic fine particle is liberated even if an apparatus and method for adding external additives are carefully designed, producing streak on an image.

To the magnetic toner of the present invention, a particle having a primary-particle number average particle diameter (D1) of 80 nm or more to 3 μm or less may be added in addition to the first inorganic fine particle mentioned above. More specifically, a lubricant such as a fluorine resin powder, a zinc stearate powder and a polyvinylidene fluoride powder; and a polishing agent such as a cerium oxide powder, a silicon carbide powder and a strontium titanate powder may be added in such a small amount that will not influence the advantageous effect of the invention.

The magnetic toner of the present invention has a weight average particle diameter (D4) of preferably 6.0 μm or more and 10.0 μm or less and more preferably 7.0 μm, or more to 9.0 μm or less, in view of balance between developability and fixability.

The magnetic toner of the present invention has an average degree of circularity of preferably 0.935 or more and 0.955 or less and more preferably 0.938 or more and 0.950 or less, from the viewpoint of suppressing charge-up.

In the magnetic toner of the present invention, the average degree of circularity thereof can be adjusted to fall within the above range by adjusting a method and conditions for producing a magnetic toner.

Now, the production method for the magnetic toner of the present invention will be described by way of examples; however the method is not limited to these examples.

The magnetic toner of the present invention can be produced by a production method known in the art. The production method is not particularly limited as long as coverage ratio A and B/A are adjusted by the method and preferably a step of adjusting the average degree of circularity is included in the method (in other words, production steps other than the step are not particularly limited).

As the production method, the following methods are preferably mentioned. First, a binder resin and a magnetic substance, and, if necessary, other materials such as a release agent and a charge control agent, are sufficiently mixed by a mixer such as a Henschel mixer or a ball mill, melted, mixed and kneaded by a heat kneader such as a roll, a kneader and extruder. In this way, resins are mutually melted with each other.

After the obtained melt-kneaded product is cooled to solidify, the resultant product is subjected to rough grinding, fine grinding and classification. To the obtained magnetic toner particle, an external additives such as an inorganic fine particle is externally added to obtain a magnetic toner.

Examples of the mixer include a Henschel mixer (manufactured by Mitsui Mining); a super mixer (manufactured by KAWATA MFG Co., Ltd.); Ribocone (manufactured by OKAWARA CORPORATION); a nauter mixer, a turbulizer, a cyclone mix, Nobilta (manufactured by Hosokawa Micron Corporation); a spiral pin mixer (manufactured by Pacific Machinery & Engineering Co., Ltd); and LODIGE Mixer (manufactured by MATSUBO Corporation).

Examples of the kneader include a KRC kneader (manufactured by KURIMOTO LTD.); Buss co-kneader (manufactured by Buss); a TEM extruder (manufactured by TOSHIBA MACHINE CO., LTD); a TEX twin-screw kneader (manufactured by The Japan Steel Works, LTD.); a PCM kneader (manufactured by Ikegai Tekkosho); a three-roll mill, a mixing roll mill, a kneader (manufactured by INOUE MANUFACTURING Co., Ltd.); Kneadex (manufactured by Mitsui Mining); MS pressure kneader, Kneader ruder (manufactured by Moriyama Manufacturing Co., Ltd.); and a Banbury mixer (manufactured by KOBE STEEL LTD.).

Examples of the grinder include a counter jet mill, a micron jet, an ionmizer (manufactured by Hosokawa Micron Group); an IDS mill and a PJM jet grinder (manufactured by NIPPON PNEUMATIC MFG. CO., LTD.); a cross jet mill (manufactured by KURIMOTO LTD.); Urmax (manufactured by NISSO ENGINEERING CO., LTD.); SK jet O mill (manufactured by SEISHIN ENTERPRISE Co., Ltd.); Cryptron (manufactured by Kawasaki Heavy Industries, Ltd.); a turbo mill (manufactured by Turbe Corporation); and a super rotor (Nisshin Engineering Inc.).

Of them, a turbo mill is used to successfully control the average degree of circularity by adjusting the exhaust temperature during micro-grinding. If the exhaust temperature is adjusted to be low (e.g., 40° C. or less), the average degree of circularity decreases. Whereas, if the exhaust temperature is adjusted to be high (e.g., around 50° C.), the average degree of circularity increases.

Examples of the classifier include Classsiel, Micron classifier, Spedic classifier (manufactured by SEISHIN ENTERPRISE Co., Ltd.); Turbo classifier (manufactured by Nisshin Engineering Inc.); a micron separator, a turbo plex (ATP), TSP separator (manufactured by manufactured by Hosokawa Micron Group); Elbow jet (manufactured by Nittetsu Mining Co., Ltd.), a dispersion separator (manufactured by NIPPON PNEUMATIC MFG. CO., LTD.); and YM microcut (manufactured by Yasukawa Corporation).

Examples of a sieve shaker for use in sieving crude particles, etc. include Ultrasonic (manufactured by Koei Sangyo Co., Ltd.); Rezona Sieve, Gyro shifter (manufactured by TOKUJU CORPORATION); Vibrasonic system (manufactured by DALTON Co., Ltd.); Soniclean (manufactured by SINTOKOGIO, LTD.); Turbo screener (manufactured by Turbo Kogyosha); Micro shifter (manufactured by Makino mfg co., Ltd.); and a circular sieve shaker.

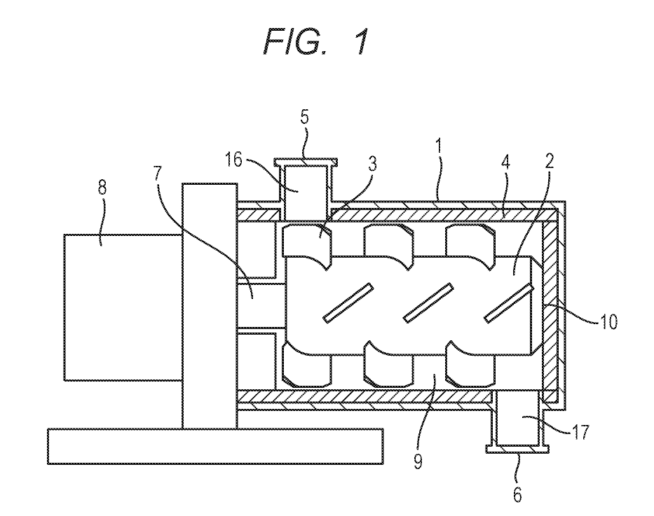

Examples of a mixing apparatus for externally adding a first inorganic fine particle, the aforementioned mixing apparatuses known in the art can be used; however, the apparatus shown in FIG. 1 is preferable in order to easily control coverage ratio A, B/A and the variation coefficient of coverage ratio A.

FIG. 1 is a schematic view illustrating a mixing apparatus that can be used for externally adding the first inorganic fine particle to be used in the present invention.

The mixing apparatus is constituted such that shear is applied to a magnetic toner particle and a first inorganic fine particle in a narrow clearance. Because of this, it is easy to adhere the first inorganic fine particle to the surface of a magnetic toner particle.

Now, measurement methods for physical properties of the present invention will be described below.

Quantification Method for Organic-Inorganic Composite Fine Particle>

When the content of an organic-inorganic composite fine particle in a magnetic toner containing a plurality of external additives (additives externally added to the magnetic toner particle) is measured, it is necessary to separate the magnetic toner particle and external additives and further separate and collect the particles whose content is to be measured from the external additives separated.

As a specific method, for example, the following methods are mentioned.

(1) A magnetic toner (5 g) is placed in a sample vial.

Methanol (200 mL) is added and further several drops of “Contaminon N” (a 10 mass % aqueous solution of a neutral detergent for washing a precision measuring apparatus, containing a nonionic surfactant, an anionic surfactant and an organic builder, pH7, manufactured by Wako Pure Chemical Industries Ltd.) are added.

(2) The sample is dispersed by an ultrasonic cleaner for 5 minutes to separate external additives.

(3) The mixture is filtered under aspiration (10 μm membrane filter) to separate magnetic toner particles and external additives.

(4) The above steps (2) and (3) are repeated three times in total.

By the above operation, the external additives are isolated from the magnetic toner particles. The aqueous solution is recovered and centrifuged to separate and collect organic-inorganic composite fine particles. Subsequently, the solvent is removed and the resultant particles are sufficiently dried by a vacuum dryer. The mass of the particles is measured to obtain the content of the organic-inorganic composite fine particles.

Quantification method for first inorganic fine particle>

(1) Quantification of the Content of Silica Fine Particles in Magnetic Toner (Standard Addition Method)

A magnetic toner (3 g) is placed in an aluminum ring having a diameter of 30 mm and a pressure of 10 tons is applied to prepare pellets. The intensity of silicon (Si) (Si intensity-1) is obtained by wavelength dispersion X-ray fluorescence analysis (XRF). Note that any measurement conditions may be used as long as they are optimized according to the XRF apparatus to be used; however, a series of intensity measurements shall be performed all in the same conditions. To the magnetic toner, a silica fine particle having a primary-particle number average particle diameter of 12 nm (1.0 mass % relative to the magnetic toner) is added and mixed by a coffee mill.

At this time, any silica fine particles can be mixed as long as they have a primary-particle number average particle diameter within 5 nm or more and 50 nm or less, without affecting the quantification.

After mixing, the silica fine particles are pelletized in the same manner as above and the intensity of Si is obtained in the same manner as above (Si intensity-2). The same operation is repeated with respect to samples obtained by adding and mixing a silica fine particle (2.0 mass % and 3.0 mass % relative to the magnetic toner) in the magnetic toner to obtain the intensity of Si (Si intensity-3, Si intensity-4). Using Si intensity-1 to -4, the silica content (mass %) in the magnetic toner is calculated by the standard addition method. Note that if a plurality of silica particles serving as a first inorganic fine particle are added, a plurality of Si intensity values are detected by XRF. Thus, in the measurement method of the invention only one type of silica particle must be used.

The titania content (mass %) and alumina content (mass %) in the magnetic toner are obtained by quantification according to the standard addition method in the same manner as in the above quantification of silica content. More specifically, the titania content (mass %) is determined by adding a titania fine particle having a primary-particle number average particle diameter of 5 nm or more and 50 nm or less, mixing them and obtaining the intensity of titanium (Ti). The alumina content (mass %) is determined by adding an alumina fine particle having a primary-particle number average particle diameter of 5 nm or more and 50 nm or less, mixing them and obtaining the intensity of aluminum (Al).

(2) Separation of First Inorganic Fine Particle from Magnetic Toner Particle

A magnetic toner (5 g) is weighed in a 200 mL polycup with a cap by a precise weighing machine. To this, methanol (100 mL) is added. The mixture is dispersed by an ultrasonic disperser for 5 minutes. While the magnetic toner is attracted by a neodymium magnet, the supernatant is discarded. The operation of dispersing with methanol and discarding the supernatant is repeated three times, and thereafter 10% NaOH (100 mL) and several drops of “Contaminon N” (a 10 mass % aqueous solution of a neutral detergent for washing a precision measuring apparatus, containing a nonionic surfactant, an anionic surfactant and an organic builder, pH7, manufactured by Wako Pure Chemical Industries Ltd.) are added and gently mixed. The resultant mixture is allowed to stand still for 24 hours. Thereafter, the mixture is separated again by use of a neodymium magnet. At this time, it should be noted that the mixture is repeatedly rinsed with distilled water so as not to leave NaOH. The particles recovered are sufficiently dried by a vacuum dryer to obtain particle A. The silica fine particles externally added are dissolved and removed by the above operation. Since the titania fine particles and alumina fine particles are hardly dissolved in a 10% NaOH, they can remain without being dissolved. If a toner has silica fine particles and other external additives, the aqueous solution from which externally added silica fine particle are removed is centrifuged and fractionated based on the difference in specific gravity. The solvent is removed from the individual fractions and the resultant fractions are sufficiently dried by a vacuum dryer and subjected to measurement of mass. In this manner, the contents of individual types of particles can be obtained.

(3) Measurement of Si Intensity in Particle A

Particle A (3 g) is placed in an aluminum ring having a diameter of 30 mm and a pressure of 10 tons is applied to prepare pellets. The intensity of Si (Si intensity-5) is obtained wavelength dispersion X-ray fluorescence analysis (XRF). Using Si intensity-5 and Si intensity-1 to 4 used in determining the silica content in the magnetic toner to calculate the silica content (mass %) in particle A.

(4) Separation of Magnetic Substance from Magnetic Toner

To particle A (5 g), tetrahydrofuran (100 mL) is added. After the solution is sufficiently mixed and then subjected to ultrasonic dispersion for 10 minutes. While the magnetic particles are attracted by a magnet, the supernatant is discarded. The operation is repeated five times to obtain particle B. Organic components such as a resin other than the magnetic substance can be substantially removed by the operation. However, there is a possibility for tetrahydrofuran insoluble matter to remain. Therefore, it is necessary to heat particle B obtained in the aforementioned operation up to 800° C. to burn the remaining organic components. Particle C obtained after heating can be regarded as the magnetic substance contained in the magnetic toner particle.

The mass of particle C can be measured to obtain magnetic-substance content W (mass %) in the magnetic toner. At this time, to correct an increase by oxidation in the content of the magnetic substance, the mass of particle C is multiplied by 0.9666 (Fe₂O₃→Fe₃O₄).

In short, Magnetic-substance content W (mass %)=((mass of particle A recovered from toner (5 g))/5)×(0.9666×(mass of particle C)/5)×100.

(5) Measurement of Ti Intensity and Al Intensity in Magnetic Substance Separated.

The contents of titania and alumina contained as impurities or additives in the magnetic substance are calculated by converting the intensity of Ti and Al detected into titania and alumina, respectively based on the FP quantification method of wavelength dispersion X-ray fluorescence analysis (XRF).

The quantification values obtained by the above technique are assigned to the following expression to calculate the amount of externally added silica fine particles, the amount of externally added titania fine particles and the amount of externally added alumina fine particles.

Amount of externally added silica fine particles (mass %)=silica content (mass %) in magnetic toner−silica content (mass %) in particle A

Amount of externally added titania fine particles (mass %)=titania content (mass %) in magnetic toner−{titania content (mass %) in magnetic substance×magnetic-substance content W (mass %)/100}

Amount of externally added alumina fine particles (mass %)=alumina content (mass %) in magnetic toner−{alumina content (mass %) in magnetic substance×magnetic-substance content W (mass %)/100}

(6) Calculation of proportion of silica fine particle in metal oxide fine particle selected from the group consisting of a silica fine particle, a titania fine particle and alumina fine particle, in a first inorganic fine particle adhered to the surface of a magnetic toner particle.

In the calculation method (described later) for coverage ratio B, after an operation of “removing an unadhered first inorganic fine particle”, the toner was dried and then subjected to the same operation as in the above methods (1) to (5). In this manner, the proportion of the silica fine particle in the metal oxide fine particle can be calculated.

Method for Determining Primary-Particle Number Average Particle Diameter of First Inorganic Fine Particle>

The primary-particle number average particle diameter of a first inorganic fine particle can be calculated based on the image of inorganic fine particles on a magnetic-toner surface photographed by a Hitachi ultrahigh resolution field-emission scanning electron microscope S-4800 (manufactured by Hitachi High-Technologies Corporation). The image-taking conditions by S-4800 are as follows.

Operations of the methods (1) to (3) are performed in the same manner as in the “Calculation of coverage ratio A”. Similarly to (4), a camera is brought into focus on a magnetic-toner surface at 50000 fold magnification and brightness is adjusted in an ABC mode. Thereafter, magnification is changed to 100000 fold and then focus is brought into the magnetic-toner in the same manner as in (4) by use of a focus knob and a STIGMA/ALIGNMENT knob and then an autofocus system is used to bring focus. The focusing operation is repeated again at 100000 fold magnification.

Thereafter, particle diameters of at least 300 inorganic fine particles a on the magnetic-toner surface are measured to obtain a number-average particle diameter (D1). Since inorganic fine particles a are sometimes present as aggregates herein, the maximum diameters of particles which can confirmed as primary particles are measured and the obtained maximum diameters are arithmetically averaged to obtain the primary-particle number average particle diameter (D1).

Calculation of Coverage Ratio A>

In the present invention, coverage ratio A is calculated by analyzing the magnetic-toner surface image, which is photographed by a Hitachi ultrahigh resolution field-emission scanning electron microscope S-4800 (manufactured by Hitachi High-Technologies Corporation), by use of image analysis software Image-Pro Plus ver.5.0 (Nippon Roper K.K.). The image taking conditions by S-4800 are as follows.

(1) Sample Preparation

A conductive paste is thinly applied to a sample stand (aluminum sample stand: 15 mm×6 mm) and a magnetic toner is sprayed on the conductive paste. Excessive magnetic toner is removed from the sample stand by air blow and the sample stand is sufficiently dried. The sample stand is set to a sample holder and the height of the sample stand is adjusted to a level of 36 mm by use of a sample height gauge.

(2) Setting Observation Conditions of S-4800

Coverage ratio A is calculated based on a reflection electron image observed under S-4800. Since the charge-up of the reflection electron image of inorganic fine particles is lower than that of a secondary electron image, coverage ratio A can be accurately measured.

In an anti-contamination trap equipped to a microscope body of S-4800, liquid nitrogen is injected until it spills over and allowed to stand still for 30 minutes. “PC-SEM” of S-4800 is started up and an FE tip (electronic source) is flashed and cleaned. In the window, acceleration voltage displayed on the control panel is clicked and the [Flashing] button is pressed to open a flash-execution dialog. After the intensity level of flashing is confirmed to be 2 and executed. Then, the emission current by flashing is confirmed to be 20 to 40 μA. A sample holder is inserted into a sample chamber of the S-4800 microscope body. A button [HOME] on the control panel is pressed to move the sample holder to a viewing position.

The “acceleration voltage” display is clicked to open the HV setting dialog. The acceleration voltage is set at [0.8 kV] and the emission current is set at [20 μA]. In the [SEM] tab of the operation panel, the signal section is set at [SE] and the SE detector is set at [Upper (U)] and [+BSE] is selected. In the selection box at the right side of [+BSE], [L.A.100] is selected to set a mode of observing a reflection electron image. In the same [SEM] tab on the operation panel, the probe current in the block of electronic optical condition is set at [Normal], the focal mode at [UHR] and WD at [3.0 mm]. In the acceleration voltage display on the control panel, button [ON] is pressed to apply the acceleration voltage.

(3) Calculation of Number-Average Particle Diameter (D1) of Magnetic Toner

In the “magnification” display on the control panel, magnification is set at 5000 (5 k) fold by dragging the mouse. On the operation panel, the focus knob [COARSE] is turned to roughly bring a focus on a sample and then aperture alignment is adjusted. On the control panel, [Align] is clicked to display the alignment dialog and then, [Beam] is selected. STIGMA/ALIGNMENT knobs (X, Y) on the operation panel are turned to move the beam displayed there to the center of concentric circles. Next, [Aperture] is selected and STIGMA/ALIGNMENT knobs (X, Y) are turned one by one to stop or minimize the movement of an image. The aperture dialog is closed and a focus is automatically brought on the sample. This operation is repeated further twice to bring a focus on the sample.

Thereafter, the diameters of 300 magnetic toner particles are measured to obtain a number-average particle diameter (D1).

Note that the particle diameter of each magnetic toner particle is specified as the maximum diameter of the magnetic toner particle observed.

(4) Focusing

The particle obtained in (3) and having a number-average particle diameter (Dl) of ±0.1 μm is placed such that the middle point of the maximum diameter is aligned with the center of the measurement screen. In this state, a mouse is dragged in the magnification display of the control panel to set magnification at 10000 (10 k) fold. Then, a focus knob [COARSE] on the operation panel is turned to roughly bring a focus on the sample. Then, aperture alignment is adjusted. On the control panel, [Align] is clicked to display the alignment dialog. Then, [beam] is selected. On the operation panel, when STIGMA/ALIGNMENT knobs (X, Y) are turned to move the beam displayed there to the center of concentric circles. Next, [Aperture] is selected and STIGMA/ALIGNMENT knobs (X, Y) are turned one by one to stop or minimize the movement of an image. The aperture dialog is closed and automatically bring a focus on the image. Thereafter, magnification is set at 50000 (50 k) fold, a focus is brought on the image by using the focus knob and STIGMA/ALIGNMENT knob in the same manner as above and a focus is again automatically brought on the sample. This operation is repeated again to bring a focus on the sample. Herein, if the inclination angle of an observation surface is large, measurement accuracy for obtaining coverage ratio is likely to decrease. Accordingly, in focusing, a sample whose surface has a low inclination angle is selected by selecting a sample on the entire surface of which comes into focus at the same time and used for analysis.

(5) Image Storage

Brightness is controlled in an ABC mode and an image having a size of 640×480 pixels is taken and stored. This image file is subjected to the following analysis. A single picture is taken per magnetic toner particle and images of at least 30 magnetic toner particles are obtained.

(6) Image Analysis

In the present invention, the images obtained by the technique described above are subjected to binarization using the following analysis software to calculate coverage ratio A. In analysis, the picture plane obtained above is split into 12 squares and individual squares are analyzed. However, if an inorganic fine particle having a particle diameter of 50 nm or more is seen in a sprit square section, calculation of coverage ratio A shall not be performed in this section.

The analysis conditions for image analysis software Image-Pro Plus ver. 5.0 are as follows: Software Image-Pro Plus 5.1J

The “Measure” of the toolbar is opened and then “Count/Size” and then “Options” are selected to set binarization conditions. In the object extraction options, 8-Connect is checked and Smoothing is set at 0. Others, i.e., “Pre-Filter”, “Fill Holes”, “Convex Hull” are unchecked, and “Clean Borders” is set at “None”. In “Measure” of the toolbar, “Select Measurements” are selected and 2 to 10⁷ is input in Filter Ranges of Area.

Coverage ratio is calculated by encircling a square region. The area (C) of the region is set so as to have 24000 to 26000 pixels. Then, “Process”-binarization is selected to perform automatic binarization. The total area (D) of the regions in which silica is not present is calculated.

Based on the area C of a square region, the total area D of the regions in which silica is not present, coverage ratio “a” is obtained according to the following expression:

Coverage ratio “a”(%)=100−C/D×100

As described above, coverage “a” is calculated with respect to 30 magnetic toner particles or more. An average value of all data obtained is regarded as coverage ratio A in the present invention.

<Variation Coefficient of Coverage Ratio A>

In the present invention, the variation coefficient of coverage ratio A is obtained as follows. Provided that the standard deviation of all coverage ratio data used in the aforementioned coverage ratio A calculation is represented by σ(A), the variation coefficient of coverage ratio A can be obtained according to the following expression:

Variation coefficient (%)={σ(A)/A}×100

<Calculation of Coverage Ratio B>

Coverage ratio B is calculated by first removing unadhered first inorganic fine particle on a magnetic-toner surface and then repeating the same operation as in calculation of coverage ratio A.

(1) Removal of unadhered first inorganic fine particle Unadhered inorganic fine particles are removed as follows. In order to sufficiently remove particles except first inorganic fine particle embedded in the surface of toner particles, the present inventors studied and determined the removal conditions.

More specifically, water (16.0 g) and Contaminon N (neutral detergent, Product No. 037-10361, manufactured by Wako Pure Chemical Industries Ltd.) (4.0 g) are placed in a 30 mL glass vial and sufficiently mixed. To the solution thus prepared, a magnetic toner (1.50 g) is added and allowed to totally precipitate by applying a magnet close to the bottom surface. Thereafter, air bubbles are removed by moving the magnet; at the same time, the magnetic toner is allowed to settle in the solution.

An ultrasonic vibrator UH-50 (titanium alloy tip having a tip diameter of φ6 mm is used, manufactured by SMT Co., Ltd.) is set such that the tip comes to the center of the vial and at a height of 5 mm from the bottom surface of the vial. Inorganic fine particles are removed by ultrasonic dispersion. After ultrasonic wave is applied for 30 minutes, the whole amount of magnetic toner is taken out and dried. At this time, application of heat is avoided as much as possible. Vacuum dry is performed at 30° C. or less.

(2) Calculation of Coverage Ratio B

Coverage ratio of the magnetic toner after dried is calculated in the same manner as in coverage ratio A as mentioned above to obtain coverage ratio B.

<Weight Average Particle Diameter (D4) of Magnetic Toner and Grain Size Distribution Measurement Method>

The weight average particle diameter (D4) of a magnetic toner is calculated as follows. As a measurement apparatus, a precise grain size distribution measurement apparatus “Coulter•counter Multisizer 3” (registered trade mark, manufactured by Beckman Coulter, Inc.) equipped with a 100 μm-aperture tube and based on the pore electrical resistance method. The accompanying dedicated software “Beckman Coulter Multisizer 3 Version 3.51” (manufactured by Beckman Coulter, Inc.) is used for setting measurement conditions and analysis of measurement data. Note that, effective measurement channels; i.e., 25000 channels are used for measurement.

An aqueous electrolyte for use in measurement is prepared by dissolving special-grade sodium chloride in ion exchange water in a concentration of about 1 mass %. For example, “ISOTON II” (manufactured by Beckman Coulter, Inc.) can be used.

Note that, before measurement and analysis, the dedicated software is set as follows.

In the window “Changing Standard Operating Method (SOM)” of the dedicated software, the total count number in the control mode is set at 50000 particles; “measurement times” is set at 1; and a value obtained by using “Standard Particles 10.0 μm” (manufactured by Beckman Coulter, Inc.) is set at as a Kd value. The “Threshold/Measure Noise Level button” is pressed to automatically set threshold and noise level. Furthermore, the current is set at 1600 μA; the gain is set at 2, the electrolytic solution is set at ISOTON II; and the “Flush Aperture Tube after each run” box is checked.

In the window “Convert Pulses to Size” of the dedicated software, the bin interval is set at logarithmic particle diameter; the particle diameter bin is set at 256 particle diameter bin; and the particle diameter range is set at 2 μm to 60 μm.

The measurement method is more specifically as follows:

(1) To a 250-ml round-bottom glass beaker for exclusive use for Multisizer 3, the aqueous electrolyte (about 200 ml) is added. The beaker is set in a sample stand, stirred counterclockwise with a stirrer rod at a rate of 24 rotations/second. The smudge and air bubbles of an aperture tube are removed in advance by the “Flush Aperture” function of the dedicated software.

(2) To a 100 ml flat-bottom glass beaker, the aqueous electrolyte about (30 ml) is added. To the beaker, a diluted solution (about 0.3 ml) of “Contaminon N” (a 10 mass % aqueous solution of a neutral detergent for washing a precision measuring apparatus, containing a nonionic surfactant, an anionic surfactant and an organic builder, pH7, manufactured by Wako Pure Chemical Industries Ltd.) prepared by diluting with ion exchange water to about three mass fold, is added.

(3) An ultrasonic disperser “Ultrasonic Dispersion System Tetora 150” (manufactured by Nikkaki Bios Co., Ltd) having an electric power of 120 W with two oscillators having an oscillatory frequency of 50 kHz installed therein so as to have a phase difference of 180° , is prepared. About 3.3 L of ion exchange water is added to the water vessel of the ultrasonic disperser, and Contaminon N (about 2 ml) is added to the water vessel.

(4) The beaker (2) is set in a beaker-immobilization hole of the ultrasonic disperser, and then the ultrasonic disperser is driven. Then, the height of the beaker is adjusted such that the resonant state of the liquid surface of the aqueous electrolyte in the beaker reaches a maximum.

(5) While the aqueous electrolyte in the beaker (4) is irradiated with ultrasonic wave, a toner (about 10 mg) is added to the aqueous electrolyte little by little and dispersed. The dispersion treatment with ultrasonic wave is further continued for 60 seconds. Note that in the ultrasonic dispersion, the temperature of water in the water vessel is appropriately adjusted so as to fall within the range of 10° C. or more and 40° C. or less.

(6) To the round-bottom beaker (1) set in the sample stand, the aqueous electrolyte (5) in which the toner is dispersed is added dropwise by use of a pipette. In this manner, the measurement concentration is adjusted to be about 5%. Measurement is performed until the number of measured particles reaches 50000.

(7) Measurement data is analyzed by dedicated software attached to the apparatus to calculate a weight average particle diameter (D4). Note that when graph/volume % is set in the dedicated software, “average diameter” displayed in the window “Analyze/Volume Statistics (Arithmetic)” is the weight average particle diameter (D4).

<Measurement of Weight Average Molecular Weight (Mw) and Average Rotation Radius (Rw) by Size Exclusion Chromatography Multi-Angle Scattering (SEC-MALLS)>

A magnetic toner (0.03 g) is dispersed in ortho-dichlorobenzene (10 mL) and shaken by a shaker at 135° C. for 24 hours and then, filtered by a 0.2 μm filter to obtain ortho-dichloro benzene soluble matter of the magnetic toner as the filtrate. The filtrate is used as a sample and measurement is performed in the following analysis conditions.

Analysis Conditions

Separation column: TSK gel GMHHR-H (20) HT×2 (manufactured by Tohso Corporation)

Column temperature: 135° C.

Mobile-phase solvent: ortho-dichloro benzene

mobile-phase flow rate: 1.0 mL/min.

Sample concentration: about 0.3%

Injection amount: 300 μL

Detector 1: Multi-angle light scattering detector (Wyatt DAWN EOS: manufactured by Wyatt)

Detector 2: Differential refractive index detector (Shodex RI-71: manufactured by SHOWA DENKO K. K.)

The obtained measurement results are analyzed by analysis software ASTRA for Windows (R) 4.73.04 (Wyatt Technology Corp.) to obtain the weight average molecular weight (Mw) and the average rotation radius (Rw).

<Measurement Method for Viscosity of Magnetic Toner by Use of Flow Tester Temperature Increasing Method>

Viscosity of a magnetic toner at 110° C. is obtained by a flow tester temperature increasing method as follows.

Using a flow tester CFT-500A (manufactured by Shimadzu Corporation), measurement is performed according to the following procedure.

A sample (1.00 g) is weighed and pressurized by a molding machine at a load of 10 MPa for one minute. The viscosity of the pressurized sample at 110° C. is measured in the following conditions and under normal-temperature normal-humidity (temperature: about 20 to 30° C., humidity: 30 to 70% RH) by use of the measurement machine described above. The measurement mode is a temperature increase mode.

| | | |
|---|---|---|
| RATE TEMP | 4.0 | D/M (° C./minute) |
| SET TEMP | 50.0 | DEG (° C.) |
| MAX TEMP | 200.0 | DEG |
| INTERVAL | 4.0 | DEG |
| PREHEAT | 300.0 | SEC (seconds) |
| LOAD | 10.0 | KGF (kg) |
| DIE (DIA) | 1.0 | MM (mm) |
| DIE (LENG) | 1.0 | MM |
| PLUNGER | 1.0 | CM² (cm²) |

<Measurement Method for Number-Average Particle Diameter of External Additive>

The number-average particle diameter of an external additive is measured by a scanning electron microscope “S-4800” (trade name; manufactured by Hitachi, Ltd.). A toner to which the external additive is externally added is observed at a magnification of at most 200,000 fold, and major axes of 100 primary particles of the external additive are measured to obtain the number-average particle diameter. The observation magnification is appropriately adjusted depending upon the particle size of the external additive.

<Measurement Method for THF-Insoluble Matter of a Resin of Organic-Inorganic Composite Fine Particle>

THF-insoluble matter of a resin of organic-inorganic composite fine particle was quantified as follows:

Organic-inorganic composite particles (about 0.1 g) are accurately weighed (Wc [g]) and placed in a centrifugation vial (for example, trade name “Oak Ridge centrifuge tube 3119-0050” (size 28.8×106.7 mm), manufactured by Nalgene) previously weighed. To the centrifugation vial, THF (20 g) is added and the centrifugation vial is allowed to stand still at room temperature for 24 hours to extract THF-soluble matter. Subsequently, the centrifugation vial was set in a centrifuge “himac CR22G” (manufactured by Hitachi Koki Co., Ltd.)and centrifuged at a temperature of 20° C. at a rate of 15,000 rotations per minute for one hour to completely precipitate THF-insoluble matter of the whole organic-inorganic composite fine particle. The centrifugation vial was taken out and the THF-soluble matter extract was separated and removed. Thereafter, the centrifugation vial having a content therein was subjected to vacuum dry at 40° C. for 8 hours. The centrifugation vial was weighed, from which the mass of the centrifugation vial previously weighed was subtracted to obtain the mass (Wr [g]) of THF-insoluble matter of the whole organic-inorganic composite fine particle.

The THF-insoluble matter [mass %] of the resin of an organic-inorganic composite fine particle was calculated according to the following expression, provided that the inorganic fine particle content in the organic-inorganic composite fine particle was represented by Wi [mass %].

THF-insoluble matter [mass %] of the resin of an organic-inorganic composite fine particle={(Wr−Wc×Wi)/Wc×(100−Wi)}×100

<Measurement Method of THF-Insoluble Matter of Resin in Organic Particle>

The THF-insoluble matter of a resin in an organic particle was obtained in the same manner as in the measurement method of THF-insoluble matter of a resin in the organic-inorganic composite particles. Since the organic particle does not contain an inorganic fine particle, calculation was made provided that Wi was 0.

In the case where THF-insoluble matter of a resin in an organic-inorganic composite fine particle is measured from a toner containing an external additive, the external additive is isolated from the toner and then measurement can be made. The toner is added to ion exchange water and ultrasonically dispersed to remove the external additive. The solution is allowed to stand still for 24 hours. The supernatant is collected and dried to isolate the external additive. In the case where a plurality of external additives are added to a toner, the supernatant is centrifugally separated to isolate the external additives and then measurement can be made.

### EXAMPLE

Now, the present invention will be more specifically described based on Examples, below. However, embodiments of the present invention are not limited by Examples. “Parts” described in Examples refer to parts by mass.

<Production Example of Low-Molecular Weight Polymer (L-1)>

To a four-neck flask, xylene (300 parts) was added. The mixture was raised in temperature and refluxed. To this, a solution mixture containing styrene (80 parts), n-butyl acrylate (20 parts) and di-tert-butyl peroxide (2 parts) serving as a polymerization initiator was added dropwise over 5 hours to obtain a low-molecular weight polymer (L-1) solution.

<Production Example of High Molecular Weight Polymer (Type H-1)>

A high molecular weight polymer was produced by fixing the types of monomers, the type of polymerization initiator and the type of chain transfer agent to those described in Table 1, and adjusting reaction temperature, the amounts of polymerization initiator and chain transfer agent. This is called high molecular weight polymer (type H-1).

Now, Production Examples of high molecular weight polymer (H-1) will be described below. In a four-neck flask, degassed water (180 parts) and an aqueous 2 mass % polyvinyl alcohol solution (20 parts) were placed and thereafter, a solution mixture containing styrene (75 parts) as monomer 1, n-butyl acrylate (25 parts) as monomer 2, divinyl benzene (0.005 parts) as crosslinking agent, t-dodecyl mercaptan (1.0 part) as a chain transfer agent and benzoyl peroxide (3.0 parts) as a polymerization initiator, was added, stirred to obtain a suspension solution. The atmosphere of the flask was sufficiently replaced with nitrogen and a reaction mixture was raised in temperature up to 85° C. to perform polymerization and maintained for 24 hours to complete polymerization of high molecular weight polymer (H-1).

<Production Examples of High Molecular Weight Polymers (TypeH-2) to (TypeH-4)>

High molecular weight polymers (type H-2) to (type H-4) were obtained in the same manner except that the type of monomer, the type of polymerization initiator, the type of chain transfer agent in high molecular weight polymer (type H-1) were changed to those described in Table 1.

TABLE 1

| Poly- | | | Polymerization | Chain transfer |
|---|---|---|---|---|
| mer | Monomer 1 | Monomer 2 | initiator | agent |
| Type | Styrene | n-Butyl | Benzoyl | t-Dodecyl- |
| H-1 | monomer | acrylate | peroxide | mercaptan |
| Type | Styrene | n-Butyl | Dilauroyl | t-Dodecyl- |
| H-2 | monomer | acrylate | peroxide | mercaptan |
| Type | Styrene | 2-Ethylhexyl | Benzoyl | t-Dodecyl- |
| H-3 | monomer | acrylate | peroxide | mercaptan |
| Type | Styrene | n-Butyl | Dilauroyl | — |
| H-4 | monomer | acrylate | peroxide | |

<Production Example of n-butyl Styrene Acrylate (St/nBA) Copolymer 1>

To the solution of the low-molecular weight polymer (L-1) (300 parts), the high molecular weight polymer (H-1) (25 parts) was added and sufficiently mixed under reflux. Thereafter, the organic solvent was distilled away to obtain n-butyl styrene acrylate copolymer 1. The acid value and hydroxyl value of copolymer 1 were 0 mg KOH/g; glass transition temperature (Tg) was 56° C.; Mw was 11000 and Rw/Mw was 5.2×10⁻³.

<Production Examples of n-butyl Styrene Acrylate (St/nBA) Copolymers 2 to 9>

n-Butyl styrene acrylate (St/nBA) copolymers 2 to 9 were produced by changing the types of high molecular weight polymers to those described in Table 2 and according to the Production Example of n-butyl styrene acrylate (St/nBA) copolymer 1.

TABLE 2

| | | | Weight average | |
|---|---|---|---|---|
| | | | molecular weight | Rw/Mw |
| Binder resin | L-form | H-form | Mw (SEC-MALLS) | (SEC-MALLS) |
| St/nBA | L-1 | Type | 11000 | 5.2 × 10⁻³ |
| copolymer 1 | | H-1 | | |
| St/nBA | L-1 | Type | 6000 | 4.9 × 10⁻³ |
| copolymer 2 | | H-4 | | |
| St/nBA | L-1 | Type | 21000 | 5.4 × 10⁻³ |
| copolymer 3 | | H-3 | | |
| St/nBA | L-1 | Type | 11000 | 2.8 × 10⁻³ |
| copolymer 4 | | H-4 | | |
| St/nBA | L-1 | Type | 11000 | 6.0 × 10⁻³ |
| copolymer 5 | | H-2 | | |
| St/nBA | L-1 | Type | 11000 | 2.4 × 10⁻³ |
| copolymer 6 | | H-4 | | |
| St/nBA | L-1 | Type | 12000 | 6.7 × 10⁻³ |
| copolymer 7 | | H-2 | | |
| St/nBA | L-1 | Type | 5800 | 4.9 × 10⁻³ |
| copolymer 8 | | H-1 | | |
| St/nBA | L-1 | Type | 23000 | 5.3 × 10⁻³ |
| copolymer 9 | | H-3 | | |

<Organic-Inorganic Composite Particles C-1 to C-6>

Organic-inorganic composite particles can be produced according to the description of Examples of WO2013/063291.

As the organic-inorganic composite particles to be used in Examples (described later), i.e., organic-inorganic composite particles C-1 to C-5, were produced according to the description of Example 1 of WO 2013/063291. Organic-inorganic composite particle C-6 was prepared according to a Production Example of Japanese Patent Application Laid-Open No. 2005-202131. The physical properties of organic-inorganic composite fine particles C-1 to C-6 are shown in Table 3.

TABLE 3

| Organic- | Number | | Particle | Content |
|---|---|---|---|---|
| inorganic | average | THF- | diameter | of |
| composite fine | diameter | insoluble | of silica | silica |
| particles | (nm) | matter (%) | (nm) | (mass %) |
| C-1 | 106 | 98 | 25 | 66.5 |
| C-2 | 210 | 97 | 50 | 32.8 |
| C-3 | 62 | 98 | 15 | 41.1 |
| C-4 | 160 | 96 | 50 | 56 |
| C-5 | 150 | 75 | 20 | 48.9 |
| C-6 | 120 | 93 | 7.9 | 30 |

<Other Additives>

In the toner Production Examples (described later), as the additives to be used except the organic-inorganic composite particles, Eposter series manufactured by NIPPON SHOKUBAI CO., LTD were used as organic particles and SEAHOSTAR series manufactured by NIPPON SHOKUBAI CO., LTD were used as inorganic particles.

### Production Example 1 of Magnetic Toner Particle

| | | |
|---|---|---|
| n-Butyl styrene acrylate copolymer 1: | 100.0 | parts |
| (shown in Table 2) | | |
| Polyethylene wax 1: (melting point 80° C.) | 5.0 | parts |
| Magnetic substance: | 95.0 | parts |
| (composition: Fe₃O₄ shape: spherical, primary-particle | | |
| number average particle diameter: 0.21 μm, magnetic | | |
| properties at 795.8 kA/m; Hc: 5.5 kA/m, σs: 84.0 | | |
| Am²/kg, σr: 6.4 Am²/kg) | | |
| Charge control agent T-77: | 1.0 | part |
| (manufactured by Hodogaya Chemical Co., LTD) | | |

The raw materials were preparatorily mixed by a Henschel mixer, FM10C (Mitsui Miike Koki), and kneaded by a twin screw kneading extruder (PCM-30: manufactured by Ikegai Tekkosho) at a rotation number of 200 rpm while adjusting the temperature such that the direct temperature of a kneaded product near the outlet became 155° C.

The melt-kneaded product obtained was cooled and roughly ground by a cutter mill. The ground product obtained was finely ground by a turbo mill T-250 (manufactured by Turbo Kogyou) in a feed amount of 20 kg/hr while adjusting air temperature so as to obtain an exhaust temperature of 38° C. and classified by a multifraction classifier using the Coanda effect to obtain magnetic toner particle 1 having a weight average particle diameter (D4) of 7.8 The results are shown in Table 4.

### Production Examples 2 to 9 of Magnetic Toner Particle

Magnetic toner particles 2 to 9 were obtained in the same manner as in Production Example 1 except that the type of binder resin in Production Example 1 of a magnetic toner particle was changed to those shown in Table 4. The production conditions and physical properties of magnetic toner particles 2 to 9 are shown in Table 4.

TABLE 4

| | | Direct | Exhaust | | Weight average | | |
|---|---|---|---|---|---|---|---|
| | | temperature | temperature | Weight average | molecular weight | (Rw/Mw) | Viscosity |
| | | of kneaded | during fine | particle diameter | at SEC MALLS | by SEC | at 110° C. |
| | Binder resin | product(° C.) | grinding(° C.) | D4 (μm) | (Mw) | MALLS | (Pa · s) |
| Magnetic toner particle 1 | St/nBA copolymer 1 | 155 | 38 | 7.8 | 10000 | 5.5 × 10⁻³ | 15000 |
| Magnetic toner particle 2 | St/nBA copolymer 2 | 160 | 38 | 7.8 | 5500 | 5.0 × 10⁻³ | 10000 |
| Magnetic toner particle 3 | St/nBA copolymer 3 | 150 | 39 | 7.8 | 19500 | 5.4 × 10⁻³ | 20000 |
| Magnetic toner particle 4 | St/nBA copolymer 4 | 155 | 38 | 7.8 | 10500 | 3.0 × 10⁻³ | 15000 |
| Magnetic toner particle 5 | St/nBA copolymer 5 | 155 | 38 | 7.8 | 9500 | 6.5 × 10⁻³ | 15000 |
| Magnetic toner particle 6 | St/nBA copolymer 6 | 155 | 38 | 7.8 | 11000 | 2.8 × 10⁻³ | 15000 |
| Magnetic toner particle 7 | St/nBA copolymer 7 | 155 | 38 | 7.8 | 10500 | 6.7 × 10⁻³ | 15000 |
| Magnetic toner particle 8 | St/nBA copolymer 8 | 155 | 40 | 7.8 | 4800 | 5.5 × 10⁻³ | 7000 |
| Magnetic toner particle 9 | St/nBA copolymer 9 | 150 | 38 | 7.8 | 22000 | 5.5 × 10⁻³ | 23000 |

### Production Example 1 of Magnetic Toner

To magnetic toner particle 1 obtained in Production Example 1 of magnetic toner particle, external additives was added by using the apparatus shown in FIG. 1.

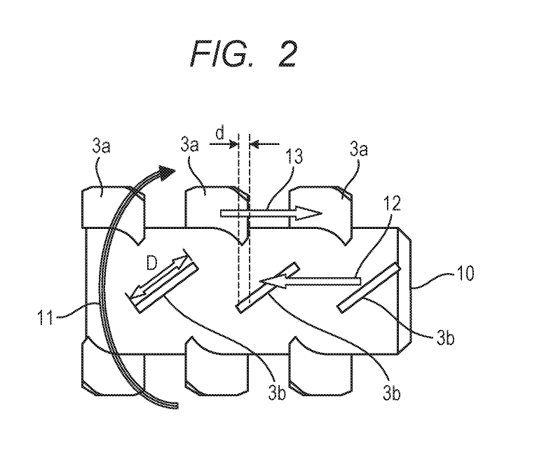

In this Example, the apparatus shown in FIG. 1 (the inner periphery diameter of main-body casing 1: 130 mm, the volume of a treatment space 9: 2.0×10⁻³ m³) was used. The rated power of a driving portion 8 was set at 5.5 kW. The shape of a stirring member 3 as shown in FIG. 2 was used. In FIG. 2, the width d of overlapped portion of a stirring member 3a with a stirring member 3b was set at 0.25D where D represents a maximum width of the stirring member 3, and the clearance between the stirring member 3 and the inner circumference of the main body casing 1 was set at 3.0 mm.

To the apparatus shown in FIG. 1 having the aforementioned constitution, the magnetic toner particle 1 (100 parts) and additives shown in Table 5 were placed.

Silica fine particle 1 was obtained by treating 100 parts of silica (BET specific surface area: 130 m²/g, a primary-particle number average particle diameter (D1):16 nm) with hexamethyldisilazane (10 parts) and subsequently with dimethyl silicone oil (10 parts).

After the magnetic toner particle and the silica fine particle were placed, premix was performed in order to uniformly mix the magnetic toner particle and the silica fine particle. The conditions for premix are as follows: power for driving portion 8: 0.1 W/g (rotation number of a driving portion 8: 150 rpm); and treatment time: 1 minute.

After completion of the premix, external additives were mixed. As conditions for an external additive mixing treatment, the circumferential speed of the outmost part of the stirring member 3 was adjusted so as to provide a constant power (the driving portion 8) of 1.0 W/g (rotation number of the driving portion 8: 1800 rpm), and a treatment was performed for 5 minutes. The conditions for the external additive mixing treatment are shown in Table 5.

After the external additive mixing treatment, rough particles and others were removed by a circular vibration sieve provided with a screen having a diameter of 500 mm and a sieve opening of 75 μm to obtain magnetic toner 1. Magnetic toner 1 was observed by a scanning electron microscope. Using a magnified view of magnetic toner 1, the primary-particle number average particle diameter of silica fine particles on the magnetic-toner surface was determined, it was 18 nm. The external addition conditions and physical properties of magnetic toner 1 are shown in Table 5 and Table 6, respectively.

TABLE 5

| | | Addition amount of external additives to toner particle (100 parts by mass) | | | | | |
|---|---|---|---|---|---|---|---|
| | | | | First inorganic fine particle | | | |
| | | Organic-inorganic | | | | | |
| | Toner | composite particle | | Silica fine particle | | Titania | Alumina |
| | particle | | Addition | | Addition | fine | fine |
| | No. | Type | amount | Type | amount | particle | particle |
| Magnetic toner 1 | 1 | C-1 | 1.1 | 1 | 2.00 | — | — |
| Magnetic toner 2 | 1 | C-2 | 1.5 | 1 | 2.00 | — | — |
| Magnetic toner 3 | 1 | C-2 | 1.5 | 1 | 1.80 | — | — |
| Magnetic toner 4 | 1 | C-2 | 1.5 | 1 | 1.80 | — | — |
| Magnetic toner 5 | 2 | C-3 | 2.0 | 1 | 2.30 | — | — |
| Magnetic toner 6 | 3 | C-4 | 0.8 | 1 | 1.60 | — | — |
| Magnetic toner 7 | 4 | C-4 | 0.8 | 1 | 1.60 | — | — |
| Magnetic toner 8 | 5 | C-3 | 2.0 | 1 | 2.30 | — | — |
| Magnetic toner 9 | 1 | C-1 | 0.6 | 1 | 2.00 | — | 0.30 |
| Magnetic toner 10 | 1 | C-1 | 2.9 | 1 | 2.00 | 0.20 | — |
| Comparative | 6 | C-2 | 1.0 | 1 | 2.20 | — | — |
| magnetic toner 1 | | | | | | | |
| Comparative | 7 | C-2 | 1.0 | 1 | 2.20 | — | — |
| magnetic toner 2 | | | | | | | |
| Comparative | 8 | C-2 | 1.0 | 1 | 2.20 | 0.20 | — |
| magnetic toner 3 | | | | | | | |
| Comparative | 9 | C-2 | 1.0 | 1 | 2.20 | 0.20 | — |
| magnetic toner 4 | | | | | | | |
| Comparative | 1 | C-2 | 1.0 | 1 | 1.00 | — | — |
| magnetic toner 5 | | | | | | | |
| Comparative | 1 | C-2 | 1.0 | 1 | 2.60 | — | — |
| magnetic toner 6 | | | | | | | |
| Comparative | 1 | C-2 | 0.3 | 1 | 2.00 | — | — |
| magnetic toner 7 | | | | | | | |
| Comparative | 1 | C-2 | 3.5 | 1 | 2.00 | — | — |
| magnetic toner 8 | | | | | | | |
| Comparative | 1 | C-5 | 1.0 | 1 | 2.00 | — | — |
| magnetic toner 9 | | | | | | | |
| Comparative | 1 | C-6 | 1.0 | 1 | 2.00 | — | — |
| magnetic toner 10 | | | | | | | |
| Comparative | 1 | — | — | 1 | 2.40 | — | — |
| magnetic toner 11 | | | | | | | |
| Comparative | 1 | (Colloidal | (1.0) | 1 | 2.00 | — | — |
| magnetic toner 12 | | silica) | | | | | |
| Comparative | 1 | (Resin | (1.0) | 1 | 2.00 | — | — |
| magnetic toner 13 | | fine | | | | | |
| | | particle) | | | | | |

| | Content (mass %) of external additives | | | | | | | |
|---|---|---|---|---|---|---|---|---|
| | based on toner particle (by mass) | | | | | | | |
| | | First inorganic fine particle | | | | | | |
| | Organic- | | | | Proportion | | | |
| | inorganic | Silica | Titania | Alumina | of silica | External addition condition | | |
| | composite | fine | fine | fine | fine particle | | Operation | Operation |
| | fine particle | particle | particle | particle | (mass %) | Apparatus | condition | time |
| Magnetic toner 1 | 1.09 | 1.98 | — | — | 100 | Apparatus | 1.0 W/g | 5 min |
| | | | | | | of FIG. 1 | (1800 rpm) | |
| Magnetic toner 2 | 1.48 | 1.97 | — | — | 100 | Apparatus | 1.0 W/g | 5 min |
| | | | | | | of FIG. 1 | (1800 rpm) | |
| Magnetic toner 3 | 1.50 | 1.77 | — | — | 100 | Henschel | 4000 rpm | 3 min |
| | | | | | | mixer | | |
| Magnetic toner 4 | 1.49 | 1.79 | — | — | 100 | Hybridizer | 6000 rpm | 5 min |
| Magnetic toner 5 | 1.98 | 2.28 | — | — | 100 | Apparatus | 1.0 W/g | 5 min |
| | | | | | | of FIG. 1 | (1800 rpm) | |
| Magnetic toner 6 | 0.79 | 1.57 | — | — | 100 | Apparatus | 1.0 W/g | 5 min |
| | | | | | | of FIG. 1 | (1800 rpm) | |
| Magnetic toner 7 | 0.78 | 1.59 | — | — | 100 | Apparatus | 1.0 W/g | 5 min |
| | | | | | | of FIG. 1 | (1800 rpm) | |
| Magnetic toner 8 | 1.99 | 2.29 | — | — | 100 | Apparatus | 1.0 W/g | 5 min |
| | | | | | | of FIG. 1 | (1800 rpm) | |
| Magnetic toner 9 | 0.58 | 1.97 | — | 0.28 | 88 | Apparatus | 1.0 W/g | 5 min |
| | | | | | | of FIG. 1 | (1800 rpm) | |
| Magnetic toner 10 | 2.87 | 1.98 | 0.19 | — | 91 | Apparatus | 1.0 W/g | 5 min |
| | | | | | | of FIG. 1 | (1800 rpm) | |
| Comparative | 0.97 | 1.17 | — | — | 100 | Apparatus | 1.0 W/g | 5 min |
| magnetic toner 1 | | | | | | of FIG. 1 | (1800 rpm) | |
| Comparative | 0.98 | 1.16 | — | — | 100 | Apparatus | 1.0 W/g | 5 min |
| magnetic toner 2 | | | | | | of FIG. 1 | (1800 rpm) | |
| Comparative | 0.99 | 1.18 | 0.18 | — | 87 | Apparatus | 1.0 W/g | 5 min |
| magnetic toner 3 | | | | | | of FIG. 1 | (1800 rpm) | |
| Comparative | 0.99 | 1.18 | 0.19 | — | 86 | Apparatus | 1.0 W/g | 5 min |
| magnetic toner 4 | | | | | | of FIG. 1 | (1800 rpm) | |
| Comparative | 0.97 | 0.99 | — | — | 100 | Apparatus | 1.0 W/g | 5 min |
| magnetic toner 5 | | | | | | of FIG. 1 | (1800 rpm) | |
| Comparative | 0.98 | 2.57 | — | — | 100 | Apparatus | 1.0 W/g | 5 min |
| magnetic toner 6 | | | | | | of FIG. 1 | (1800 rpm) | |
| Comparative | 0.28 | 1.97 | — | — | 100 | Apparatus | 1.0 W/g | 5 min |
| magnetic toner 7 | | | | | | of FIG. 1 | (1800 rpm) | |
| Comparative | 3.47 | 1.96 | — | — | 100 | Apparatus | 1.0 W/g | 5 min |
| magnetic toner 8 | | | | | | of FIG. 1 | (1800 rpm) | |
| Comparative | 0.97 | 1.99 | — | — | 100 | Apparatus | 1.0 W/g | 5 min |
| magnetic toner 9 | | | | | | of FIG. 1 | (1800 rpm) | |
| Comparative | 0.97 | 1.99 | — | — | 100 | Apparatus | 1.0 W/g | 5 min |
| magnetic toner 10 | | | | | | of FIG. 1 | (1800 rpm) | |
| Comparative | — | 2.37 | — | — | 100 | Apparatus | 1.0 W/g | 5 min |
| magnetic toner 11 | | | | | | of FIG. 1 | (1800 rpm) | |
| Comparative | — | 2.97 | — | — | — | Apparatus | 1.0 W/g | 5 min |
| magnetic toner 12 | | (*1) | | | | of FIG. 1 | (1800 rpm) | |
| Comparative | (0.98) | 1.98 | — | — | 100 | Apparatus | 1.0 W/g | 5 min |
| magnetic toner 13 | | | | | | of FIG. 1 | (1800 rpm) | |

(*1): Total amount of colloidal silica and silica fine particle

TABLE 6

| | Coverage | | Variation |
|---|---|---|---|
| | ratio A | B/A | coefficient |
| | (%) | (—) | (%) |
| Magnetic toner 1 | 55.0 | 0.70 | 6.6 |
| Magnetic toner 2 | 55.0 | 0.70 | 6.6 |
| Magnetic toner 3 | 50.0 | 0.41 | 18.0 |
| Magnetic toner 4 | 50.0 | 0.88 | 11.0 |
| Magnetic toner 5 | 62.0 | 0.55 | 5.0 |
| Magnetic toner 6 | 48.0 | 0.80 | 7.3 |
| Magnetic toner 7 | 48.0 | 0.80 | 7.5 |
| Magnetic toner 8 | 62.0 | 0.55 | 4.9 |
| Magnetic toner 9 | 55.0 | 0.68 | 6.5 |
| Magnetic toner 10 | 55.0 | 0.69 | 6.5 |
| Comparative | 60.0 | 0.55 | 8.5 |
| magnetic toner 1 | | | |
| Comparative | 60.0 | 0.55 | 8.5 |
| magnetic toner 2 | | | |
| Comparative | 60.0 | 0.55 | 8.5 |
| magnetic toner 3 | | | |
| Comparative | 60.0 | 0.55 | 8.5 |
| magnetic toner 4 | | | |
| Comparative | 40.0 | 0.8 | 9.5 |
| magnetic toner 5 | | | |
| Comparative | 75.0 | 0.5 | 4.5 |
| magnetic toner 6 | | | |
| Comparative | 55.0 | 0.78 | 6.5 |
| magnetic toner 7 | | | |
| Comparative | 55.0 | 0.6 | 8.0 |
| magnetic toner 8 | | | |
| Comparative | 55.0 | 0.7 | 7.0 |
| magnetic toner 9 | | | |
| Comparative | 55.0 | 0.7 | 8.0 |
| magnetic toner 10 | | | |
| Comparative | 65.0 | 0.6 | 6.5 |
| magnetic toner 11 | | | |
| Comparative | 55.0 | 0.7 | 8.0 |
| magnetic toner 12 | | | |
| Comparative | 55.0 | 0.7 | 8.0 |
| magnetic toner 13 | | | |

<Evaluation of End-Portion Offset>

Fixation of toner 1 was evaluated as follows: A laser beam printer: HP LaserJet M455 manufactured by Hewlett-Packard Company, was modified such that fixation temperature can be adjusted and process speed can be arbitrarily set.

Using the above apparatus, an experiment was performed using a paper sheet of 66 g/m² at a temperature of 23° C., under an environment of a humidity 50% RH. A process speed was set at 350 mm/sec and a fixing temperature was fixed to 210° C. First a lateral-line pattern (a printing ratio of 5%) was printed on twenty A5 size paper sheets and continuously on ten A4 size paper sheets. How many A4 paper sheets (counted from the beginning) have end-portion offset was visually checked. End-portion offset was evaluated based on the following criteria. The end-portion offset resistance is evaluated as excellent if end-portion offset disappears in fewer number of paper sheets. The results are shown in Table 7.

A: No occurrence of end-portion offset

B: End-portion offset disappears up to 5 sheets

C: End-portion offset disappears up to 5 sheets but the occurrence level of end-portion offset on the first sheet is unacceptable in practical use

D: End-portion offset does not disappear up to 10 sheets or more

<Evaluation of Developability>

A predetermined process cartridge was charged with a toner. An experiment was performed using a paper sheet of 81.4 g/m². A lateral-line pattern (a printing ratio of 2%) was printed on two sheets per job and continuously printed on 2000 paper sheets and image density was measured. Evaluation was made under a normal-temperature normal-humidity environment (23.0° C., 50% RH). The image density was measured by determining the reflecting density of a 5-mm circular solid image by a reflecting densitometer, i.e., Macbeth densitometer (manufactured by Macbeth) using an SPI filter. The evaluation results are shown in Table 7.

A: Reflecting density of 1.3 or more is maintained from the beginning to 2000 sheets

B: Reflecting density is 1.3 or more in the beginning but a value of 1.3 cannot be maintained after 2000 sheets

C: Reflecting density of 1.3 cannot be maintained from the beginning.

<Evaluation of Low-Temperature Fixability>

The same printing experiment as in the evaluation of developability was performed at a temperature of 23° C. under an environment of a humidity of 50% RH. At this time, fixation was performed by adjusting the temperature at two levels, i.e., 210° C. and 190° C. Note that “Plover Bond Paper” (105 g/m², manufactured by Fox River Company) was used as a recording medium. The fixed image thus obtained was rubbed by lens-cleaning paper to which a load of 4.9 kPa (50 g/cm²) was applied. A decreasing rate (%) of image density before and after rubbing was obtained. Low-temperature fixability was evaluated based on the image density decreasing rate. The evaluation results are shown in Table 7.

A: The image density decreasing rate is less than 5.0%.

B: The image density decreasing rate is 5.0% or more and less than 10.0%.

C: The image density decreasing rate is 10.0% or more and less than 15.0%.

D: The image density decreasing rate is 15.0% or more.

### Examples 2 to 10

Toners 2 to 10 were prepared in the same manner as Example 1 according to the formulations shown in Table 5. The values of the physical properties of the toners thus obtained are shown in Table 6. The same test as above were performed and the results are shown in Table 7.

### Comparative Examples 1 to 13

Comparative toners 1 to 13 were prepared in the same manner as Example 1 according to the formulations shown in Table 5. The values of the physical properties of the toners thus obtained are shown in Table 6. The same test as above were performed and the results are shown in Table 7.

TABLE 7

| | | End-portion | | |
|---|---|---|---|---|
| | | offset | Develop- | Low-temperature |
| | | resistance | ability | fixability |
| Example 1 | Magnetic | B | A | B |
| | toner 1 | | | |
| Example 2 | Magnetic | B | B | B |
| | toner 2 | | | |
| Example 3 | Magnetic | B | B | B |
| | toner 3 | | | |
| Example 4 | Magnetic | B | B | B |
| | toner 4 | | | |
| Example 5 | Magnetic | C | B | C |
| | toner 5 | | | |
| Example 6 | Magnetic | B | A | C |
| | toner 6 | | | |
| Example 7 | Magnetic | C | A | C |
| | toner 7 | | | |
| Example 8 | Magnetic | B | B | C |
| | toner 8 | | | |
| Example 9 | Magnetic | B | C | B |
| | toner 9 | | | |
| Example 10 | Magnetic | B | A | C |
| | toner 10 | | | |
| Comparative | Comparative | D | A | C |
| Example 1 | magnetic | | | |
| | toner 1 | | | |
| Comparative | Comparative | B | A | C |
| Example 2 | magnetic | | | |
| | toner 2 | | | |
| Comparative | Comparative | D | C | B |
| Example 3 | magnetic | | | |
| | toner 3 | | | |
| Comparative | Comparative | B | B | D |
| Example 4 | magnetic | | | |
| | toner 4 | | | |
| Comparative | Comparative | B | B | C |
| Example 5 | magnetic | | | |
| | toner 5 | | | |
| Comparative | Comparative | B | A | D |
| Example 6 | magnetic | | | |
| | toner 6 | | | |
| Comparative | Comparative | C | C | C |
| Example 7 | magnetic | | | |
| | toner 7 | | | |
| Comparative | Comparative | B | B | C |
| Example 8 | magnetic | | | |
| | toner 8 | | | |
| Comparative | Comparative | C | C | B |
| Example 9 | magnetic | | | |
| | toner 9 | | | |
| Comparative | Comparative | B | C | C |
| Example 10 | magnetic | | | |
| | toner 10 | | | |
| Comparative | Comparative | C | C | B |
| Example 11 | magnetic | | | |
| | toner 11 | | | |
| Comparative | Comparative | C | C | C |
| Example 12 | magnetic | | | |
| | toner 12 | | | |
| Comparative | Comparative | C | C | C |
| Example 13 | magnetic | | | |
| | toner 13 | | | |

### REFERENCE SIGNS LIST

1: main-body casing, 2: rotating body, 3, 3a, 3b: stirring member, 4: jacket, 5: raw material feed port, 6: Product ejection port, 7: center axis, 8: driving portion, 9: treatment space, 10: rotating body end parts)side surface, 11: rotation direction, 12: backward direction, 13: feed direction, 16: inner piece for a raw material feed port, 17: inner piece for product ejection port, d: width of overlapped portion of stirring members, D: width of a stirring member, 100: electrostatic latent image carrier (photoreceptor), 102: toner carrier, 103: development blade, 114: transfer member (transfer charging roller), 116: cleaner container, 117: charging member (charging roller), 121: laser generator (latent image forming unit, light exposure apparatus), 123: laser, 124: pick-up roller, 125: handler belt, 126: fixing unit, 140: developer, 141: stirring member

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2013-158910, filed Jul. 31, 2013, which is hereby incorporated by reference herein in its entirety.

1. A magnetic toner comprising:
a toner particle containing a styrene resin as a binder resin and a magnetic sub stance,
a first inorganic fine particle on surface of the toner particle and
an organic-inorganic composite fine particle on the surface of the toner particle,
wherein:
the first inorganic fine particle
i) contains at least one inorganic oxide fine particle selected from the group consisting of silica fine particle, titanium oxide fine particle and alumina fine particle, with the proviso that the inorganic oxide fine particle contains silica fine particle in an amount of 85 mass % or more based on the total mass of the inorganic oxide fine particle, and
ii) has a number-average particle diameter (D1) of 5 nm or more and 25 nm or less,
the coverage ratio A of the toner-particle surface with the first inorganic fine particle is 45.0% or more and 70.0% or less,
wherein:
the organic-inorganic composite fine particle comprises
a vinyl resin particle, and
a second inorganic fine particle embedded in the vinyl resin particle,
the vinyl resin particle comprises a vinyl resin component containing THF-insoluble matter in an amount of 95 mass % or more based on the mass of the vinyl resin component,
the content of the organic-inorganic composite fine particle is 0.5 mass % or more and 3.0 mass % or less based on the mass of the toner particle,
wherein:
when
the weight average molecular weight of THF-soluble matter of the toner measured by size exclusion chromatography multi-angle scattering (SEC-MALLS) is defined as Mw, and
an average rotation radius of THF-soluble matter of the toner measured by size exclusion chromatography multi-angle scattering (SEC-MALLS) is defined as Rw,
the Mw is 5000 or more and 20000 or less, and
the ratio of the Rw to Mw, (Rw/Mw) is 3.0×10⁻³ or more and 6.5×10⁻³ or less, and
wherein:
the viscosity of the toner at 110° C. measured by a flow tester is 5000 Pa·s or more and 25000 Pa·s or less.

2. The magnetic toner according to claim 1, wherein provided that coverage ratio of the surface of the toner-particle with the first inorganic fine particle adhered thereto is defined as B (%), B/A is 0.50 or more and 0.85 or less.

3. The magnetic toner according to claim 1, wherein a variation coefficient of the coverage ratio A is 10.0% or less.

4. The magnetic toner according to claim 1, wherein the organic-inorganic composite fine particle has a plurality of convexes derived from the second inorganic fine particle in a surface thereof and has a number-average particle diameter of 50 nm or more and 200 nm or less.
